(19) United States
(12) Patent Application Publication
(10) Pub. No.: US 2018/0265385 A1
(43) Pub. Date: Sep. 20, 2018

(54) WATER TREATMENT APPARATUS AND WATER TREATMENT METHOD

(71) Applicant: MITSUBISHI ELECTRIC CORPORATION, Tokyo (JP)

(72) Inventors: Tokiko YAMAUCHI, Chiyoda-ku (JP); Nozomu YASUNAGA, Chiyoda-ku (JP)

(73) Assignee: Mitsubishi Electric Corporation, Tokyo (JP)

(21) Appl. No.: 15/541,421

(22) PCT Filed: Jan. 21, 2016
(86) PCT No.: PCT/JP2016/051714

§ 371 Date: Jul. 3, 2017

(30) Foreign Application Priority Data
Jan. 30, 2015 (JP) 2015-017032

(51) Int. Cl. C02F 9/00

(52) U.S. Cl. CPC C02F 9/00; C02F 2209/235; C02F 2101/30; C02F 2209/38; C02F 2209/02

(57) ABSTRACT

This invention is concerning a water treatment apparatus having: an ozone injection facility configured to inject ozone gas into a treatment tank into which untreated water is introduced to be stored therein; a measuring unit configured to measure a spectral light intensity of the untreated water in a plurality of locations in the treatment tank by using at least a first wavelength; and a controller configured to estimate a residual rate of the spectral light intensity at a first wavelength for treated water, which has been treated with ozone in the treatment tank or for both the treated water and the untreated water, based on measurement results in the plurality of locations, measured by the measuring unit, and controls an ozone injection rate used by the ozone injection facility using the estimated residual rate.

### TECHNICAL FIELD

This invention relates to a control water treatment apparatus and a water treatment method, which implement optimum ozone injection control in real-time in accordance with the changes of water quality and flow rate.

### BACKGROUND ART

The humic substance contained in raw water is known as a precursor of trihalomethane (hereafter called “THM”). The humic substance is an organic substance that is difficult to decompose, is hard to remove by conventional water purification treatment, and promotes the generation of THM if chlorine treatment is performed for disinfection.

To suppress the generation of THM, which is a carcinogenic substance, advanced ozone water purification treatment is used in purification plants. In advanced ozone water purification treatment, organic substances in raw water are decomposed by oxidation using the strong oxidizing power of ozone. Ozone decomposes and eliminates the humic substance from raw water, hence the ozone treatment is effective in reducing trihalomethane forming potential (THMFP).

In this ozone treatment, the ozone injected into the untreated water reacts with the organic substance, and is consumed, and unreacted ozone is detected as dissolved ozone. Therefore if more than necessary amount of ozone is injected into the untreated water to decompose the dissolved organic substance, the dissolved ozone concentration increases. And if the dissolved ozone concentration increases, the bromide ions in the untreated water are oxidized, and a disinfection by-product, such as bromate, is generated.

Bromate is a suspected carcinogenic substance, therefore bromate in tap water is restricted to 10 μg/L or less based on the water quality standards of water supply laws. To suppress the generation of bromate, the ozone injection rate must be controlled. Normally the dissolved ozone concentration constant control method, which controls the ozone injection rate based on the dissolved ozone concentration of the treated water, is performed.

In this dissolved ozone concentration constant control method, the generation of bromate is suppressed to control keep the dissolved ozone concentration to be as low as possible. However, in a high water temperature period, such as summer time, bromate that is equal to or higher than the reference value is sometimes detected when the dissolved ozone is detected. This is probably because the self-decomposition speed of ozone is fast, and the concentration of the dissolved ozone in the treated water is controlled to be higher than the measured value of the dissolved ozone concentration.

Controlling the dissolved ozone concentration to be low is effective to suppress the generation of bromate, but THMFP, which is the original target of ozone treatment, may not be sufficiently reduced.

Therefore control of the ozone injection rate in accordance with the water quality of the untreated water is under examination, and a method based on the relationship between the ultraviolet respective absorbances at a 254 nm wavelength of the untreated water and the treated water was proposed (e.g. see PTL 1). A method of controlling the ozone injection rate based on the relationship between the fluorescence intensity of the untreated water and the ozone consumption efficiency was also proposed (e.g. see PTL 2).

### CITATION LIST

### Patent Literature

[PTL 1] Japanese Patent Application Publication No. H2-277596

[PTL 2] Japanese Patent No. 4660211

### SUMMARY OF INVENTION

### Technical Problem

However, the prior arts have the following problems.

In the ozone injection rate control method according to PTL 1, an experiment to determine the reaction characteristics between the untreated water and ozone is performed in advance, and the ozone injection rate is controlled based on this experiment result. Therefore if the water quality of the untreated water changes, depending on the weather and the season, the ozone injection rate cannot be controlled appropriately.

In PTL 2, on the other hand, the ozone injection rate is controlled based on the ozone consumption efficiency. In other words, the results of an ozone treatment, such as an injected ozone gas concentration, an exhausted ozone gas concentration, and a dissolved ozone concentration, are reflected in the control of the ozone injection rate. Therefore the ozone injection rate cannot be controlled appropriately in real-time, in accordance with the change in the water quality of the untreated water. Further, the value of the dissolved ozone concentration is used to calculate the ozone consumption efficiency. This means that in such a high water temperature period as summer time, the generation of bromate may increase.

With the foregoing in view, it is an object of the present invention to provide a water treatment apparatus and a water treatment method that can control the ozone injection rate appropriately, in accordance with the changes in the water quality and the flow rate, and can suppress the generation of bromate, and decompose and eliminate organic substances even during a high water temperature period.

### Solution to Problem

A water treatment apparatus according to this invention has: an ozone injection facility configured to inject ozone gas into a treatment tank into which untreated water is introduced to be stored therein; a measuring unit configured to sure a spectral light intensity of the untreated water in a plurality of locations in the treatment tank by using at least a first wavelength; and a controller configured to estimate a residual rate of the spectral light intensity at the first wavelength for treated water, which has been treated with ozone in the treatment tank or for both the treated water and the untreated water, based on measurement results in the plurality of locations, measured by the measuring unit, and control an ozone injection rate used by the ozone injection facility by using the estimated residual rate.

Another water treatment apparatus to this invention has: an ozone injection facility configured to inject ozone gas into a treatment tank into which untreated water is introduced to be stored therein; a first measuring instrument configured to measure ultraviolet absorbance at two or more types of wavelengths, including a first wavelength and a second wavelength, for the untreated water introduced into the processing tank; a third measuring instrument configured to measure the ultraviolet absorbance at the first wavelength for the treated water which has been treated with ozone in the treatment tank; a controller configured to control an ozone injection rate of the ozone injection facility, based on measurement results by the first measuring instrument and the third measurement instrument; and a compact treatment apparatus configured to introduce the untreated water, perform ozone treatment thereon, and calculate a target value of the ozone injection rate in real-time, based on a result of the ozone treatment, wherein the controller calculates the residual rate measured value of the ultraviolet absorbance at the first wavelength of the treated water dividing the measured value of at the first wavelength of the third measuring instrument by the measured value at the first wavelength of the first measuring instrument, and controls the ozone injection rate so as to minimize a difference between a target value of the ozone injection rate calculated by the compact water treatment apparatus and the residual rate measured value of the ultraviolet absorbance at the first wavelength of the treated water.

A water treatment method according to this invention is a water treatment method used for a water treatment apparatus having: an ozone injection facility configured to inject ozone gas into a treatment tank into which untreated water is introduced to be stored therein; a first measuring instrument configured to measure ultraviolet absorbance at two or more types of wavelengths, including a first wavelength and a second wavelength, for the untreated water introduced into the treatment tank; a third measuring instrument configured to measure ultraviolet absorbance at a first wavelength for treated water which has been treated with ozone in the treatment tank; and a controller configured to control an ozone injection rate of the ozone injection facility, based on the measurement results by the first measuring instrument and the third measuring instrument, the method executed by the controller including: a step of calculating a residual rate estimated value of the ultraviolet absorbance at the first wavelength of the treated water from the measured value at the second wavelength by the first measuring instrument, and setting the calculated value as a target value; a step of calculating a residual rate measured value of the ultraviolet absorbance at the first wavelength of the treated water by dividing the measured value at the first wavelength of the third measuring instrument by the measured value at the first wavelength of the first measuring instrument; and a step of controlling the ozone injection rate, so as to minimize a difference between the residual rate estimated value of the ultraviolet absorbance at the first wavelength, which has been set as the target value, and the residual rate measured value of the ultraviolet absorbance at the first wavelength of the treated water.

Another water treatment method according to this invention is a water treatment method used for a water treatment apparatus having: an ozone injection facility configured to inject ozone gas into a treatment tank where untreated water is introduced and stored; a first measuring instrument configured to measure a spectral light intensity at a first wavelength for the untreated water in a first measurement location which is set at the entrance of the treatment tank; a second measuring instrument configured to measure a spectral light intensity at the first wavelength for the untreated water in a second measurement location which is set inside the treatment tank; a third measuring instrument configured to measure the spectral light intensity at the first wavelength for treated water, which was being treated with ozone in the treatment tank in a third measurement location which is set at the exit of the treatment tank; and a controller configured to control the ozone injection rate by the ozone injection facility, based on the measurement results by the first measuring instrument, the second measuring instrument, and the third measuring instrument, wherein the controller executes: a step of calculating, as a first residual rate, the residual rate of the spectral light intensity at the first wavelength of the untreated water in the first measurement location, based on the measured value by the first measuring instrument; a step of calculating, as a second residual rate, the residual rate of the spectral light intensity at the first wavelength of the untreated water in the second measurement location, based on the measured value by the second measuring instrument; a step of calculating, as a third residual rate, the residual rate of the spectral light intensity at the first wavelength of the treated water in the third measurement location, based on the measured value by the third measuring instrument; a step of generating a linear function derived from the first residue rate and the second residual rate; a step of calculating an independent variable in the linear function where the third residual rate is a dependent variable; and a step of controlling the ozone injection rate, based on the calculated independent variable.

### Advantageous Effects of Invention

According to this invention, the water treatment apparatus has a configuration to estimate the ozone injection rate required for decomposing the organic substances in the untreated water based on the water quality of the untreated water. As a result, [the ozone injection rate] can be appropriately controlled in real-time in accordance with the change in the water quality, ozone required for decomposing the organic substances can be accurately injected into the untreated water, and a water treatment apparatus and a water treatment method, which allow to sufficiently decompose organic substances and suppress the generation of bromate, can be implemented.

### BRIEF DESCRIPTION OF DRAWINGS

FIG. 1 is a diagram depicting a configuration of a water treatment apparatus according to Embodiment 1 of this invention.

FIG. 2 is a flow chart depicting a series of operations of the water treatment method performed by the water treatment apparatus according to Embodiment 1 at this invention.

FIG. 3 is a diagram depicting each relationship of the UV 254 residual rate and the dissolved ozone concentration with the ozone injection rate when the untreated water, of which water source is a river, is treated with ozone by the water treatment apparatus according to Embodiment 1 of this invention.

FIG. 4 is a diagram depicting the changes in absorbance of three types of untreated water at a 200 nm wavelength to a 300 nm wavelength according to Embodiment 1 of this invention.

FIG. 5 is a diagram depicting a relationship of the UV 210 of untreated water and the UV 254 residual rate at the inflection point according to Embodiment 1 of this invention.

FIG. 6 is a diagram depicting a configuration of a water treatment apparatus according to Embodiment 2 of this invention.

FIG. 7 is a diagram depicting a relationship of the generation amount of bromate with the water temperature of the untreated water according to Embodiment 2 of this invention.

FIG. 8 is a flow chart depicting a series of operations of the water treatment method performed by the water treatment apparatus according to Embodiment 2 of this invention.

FIG. 9 is a diagram depicting a configuration of a water treatment apparatus according to Embodiment 3 of this invention.

FIG. 10 is a diagram depicting a configuration of a compact water treatment apparatus according to Embodiment 3 of this invention.

FIG. 11 is a diagram depicting a series of operations of the water treatment method performed by the water treatment apparatus according to Embodiment 3 of this invention.

FIG. 12 is a diagram depicting a configuration of a water treatment apparatus according to Embodiment 4 of this invention.

FIG. 13 is a diagram depicting a configuration of a spectral light intensity measuring unit 42 according to Embodiment 4 of this invention.

FIG. 14 is a flow chart depicting a series of operations of the water treatment method performed by the water treatment apparatus according to Embodiment 4 of this invention.

FIG. 15 is a diagram of an experiment result depicting each relationship of the UV 254 residual rate and the dissolved ozone concentration, with the ozone injection rate, when the untreated water 3 is treated with ozone by the water treatment apparatus according to Embodiment 4 of this invention.

FIG. 16 is a diagram depicting each relationship of the UV 254 residual rate and the dissolved ozone concentration with the ozone injection rate, when the untreated water 3 is treated with ozone by the water treatment apparatus according to Embodiment 4 of this invention and the ozone injection rate at this time is insufficient.

FIG. 17 is a flow chart depicting a series of operations of the water treatment method performed by the water treatment apparatus according to Embodiment 5 of this invention.

FIG. 18 is a diagram depicting the changes in the UV 254 residual rate and the dissolved ozone with respect to the ozone injection rate respectively when the untreated water 3 is treated with ozone at a predetermined water temperature or less, using the water treatment method according to Embodiment 5 of this invention.

### DESCRIPTION OF EMBODIMENTS

Preferred embodiments of the water treatment apparatus and the water treatment method of this invention will be described with reference to the drawings.

### Embodiment 1

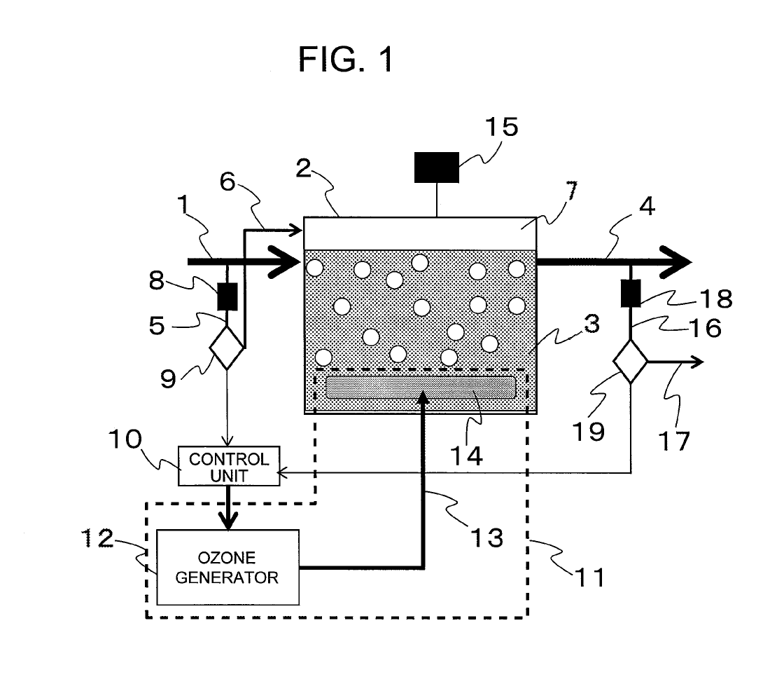

FIG. 1 is a diagram depicting a configuration of a water treatment apparatus according to Embodiment 1 of this invention. The water treatment apparatus according to Embodiment 1 is applied to an advanced water purification treatment combining ozone treatment and biological activated carbon treatment. The biological activated carbon treatment, however, is not always required.

In the water treatment apparatus depicted in FIG. 1, an untreated water pipe 1 is connected to an ozone treatment tank 2, and a treated water pipe 4 is connected to a subsequent stage of the ozone treatment tank 2. Untreated water 3 is stored in the ozone treatment tank 2.

A first untreated water branch pipe 5 is connected to the untreated water pipe 1, and the first untreated water branch pipe 5 is connected to a first ultraviolet absorbance measuring instrument 9 via a first suspended substance eliminator 8. A second untreated water branch pipe 6, which extends from the first ultraviolet absorbance measuring instrument 9, is connected to a reaction tank upper space 7 of the ozone treatment tank 2.

A first treated water branch pipe 16 is connected to the treated water pipe 4. The first treated water branch pipe 16 is connected to a second ultraviolet absorbance measuring instrument 19 via a second suspended substance eliminator 18. A second treated water branch pipe 17 is connected to the second ultraviolet absorbance measuring instrument 19.

Measured values, which are measured by the first ultraviolet absorbance measuring instrument 9 and the second ultraviolet absorbance measuring instrument 19, are sent to a control unit (controller) 10. The control unit 10 is connected to a first ozone injector 11. The first ozone injector 11 is constituted by an ozone generator 12, an ozone gas pipe 13, and an ozone gas diffuser pipe 14. The ozone gas diffuser pipe 14 is disposed at the bottom part of the ozone treatment tank 2. An exhaust ozone gas treatment apparatus 15 is connected to the upper part of the ozone treatment tank 2.

The first ultraviolet absorbance measuring instrument 9 measures the ultraviolet absorbance of the untreated water 3 at any of the two or more types of wavelengths. For this measurement, according to Embodiment 1, it is assumed that the first wavelength measurement range is 240 nm to 270 nm, which is correlated with dissolved organic substances, and the second wavelength measurement range is 200 nm to 230 nm.

The second ultraviolet absorbance measuring instrument 19 measures the ultraviolet absorbance at any wavelength of the treated water. In Embodiment 1, it is assumed that the wavelength measurement range is 240 nm to 270 nm, which is correlated with organic substances. A fluorescence intensity measuring instrument may be used, instead of the first ultraviolet absorbance measuring instrument 9 or the second ultraviolet absorbance measuring instrument 19.

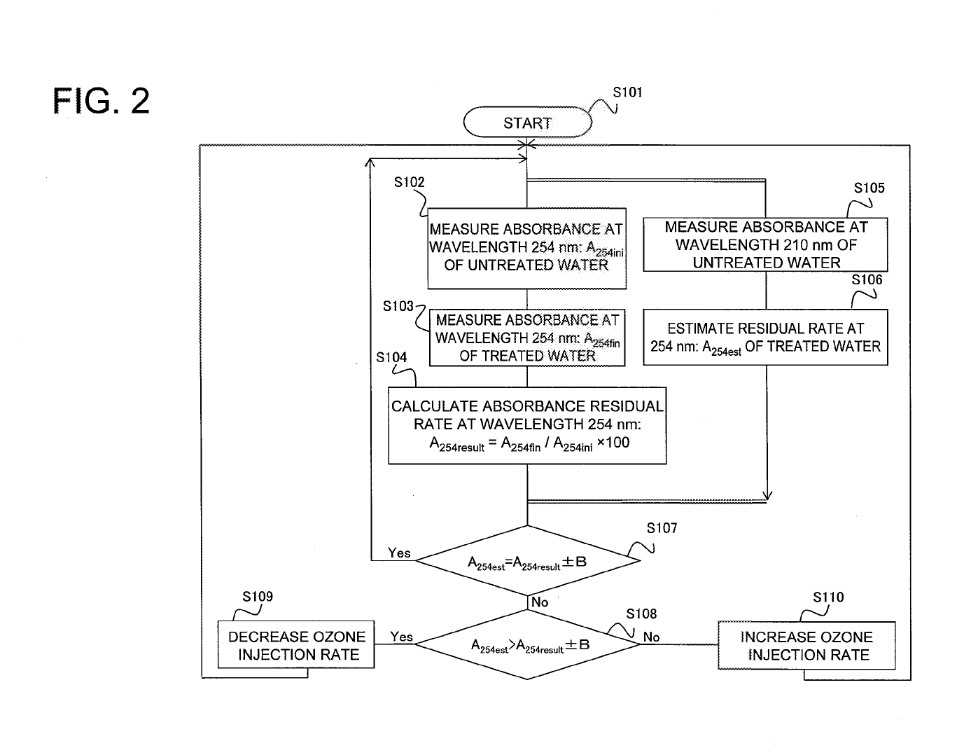

FIG. 2 is a flow chart depicting a series of operations of the water treatment method performed by the water treatment apparatus according to Embodiment 1 of this invention. In step S101 of the flow chart in FIG. 2, it is assumed that the untreated water 3 is contained in the ozone treatment tank 2, and the water treatment method of Embodiment 1 is started in a state where the ozone treatment is performed for the untreated water 3.

In the preceding stage of the first ultraviolet absorbance measuring instrument 9 (not included in FIG. 2), the suspended substances in the untreated water 3 are eliminated by the first suspended substance eliminator 8, as a pre-treatment to measure the ultraviolet absorbance of the untreated water 3. Then in step S102, the first ultraviolet absorbance measuring instrument 9 measures the ultraviolet absorbance at a 254 nm wavelength (hereafter called UV 254) for the untreated water 3 after the suspended substances are eliminated and the result is regarded as A₂₅₄ᵢₙᵢ.

In step S105, the first ultraviolet absorbance measuring instrument 9 measures the ultraviolet absorbance at a 210 nm wavelength (hereafter called UV 210). These measurements in step S102 and step S105 are performed in parallel Therefore in FIG. 2, the lateral line branching into step S102 and step S105 is indicated as a double line.

Then in step S106, the control unit 10 estimates the UV 254 residual rate estimated value A₂₅₄ₑₛₜ of the treated water, using UV 210 of the untreated water 3 measured by the first ultraviolet absorbance measuring instrument 9.

In the preceding stage of the second ultraviolet absorbance measuring instrument 19 (not included in FIG. 2), the suspended substances in the treated water are eliminated by the second suspended substance eliminator 18, as a pre-treatment to measure the ultraviolet absorbance of the treated water. Then in step S103, the second ultraviolet absorbance measuring instrument 19 measures UV 254 for the treated water after the suspended substances are eliminated, and the result is regarded as A_{254fin}.

Then in step S104, the control unit 10 calculates the UV 254 residual rate A₂₅₄ᵣₑₛᵤₗₜ using the following Expression (1).

UV 254 residual rate A₂₅₄ᵣₑₛᵤₗₜ=A_{254fin}/A₂₅₄ᵢₙᵢ×100 (1)

The untreated water 3 and the treated water, used for measuring the ultraviolet absorbance, may be disposed or returned to a water treatment step. The treatment in step S102 and step S105 and subsequent treatment may be one continuous treatment.

Then in step S107, the control unit 10 compares the relationship of the UV 254 residual rate A₂₅₄ᵣₑₛᵤₗₜ calculated in step S104, and the UV 254 residual rate estimated value A₂₅₄ₑₛₜ estimated in step S106, with the following Expression (2).

UV 254 residual rate estimated value A₂₅₄ₑₛₜ=UV 254 residual rate A₂₅₄ᵣₑₛᵤₗₜ±B (2)

B in the above Expression (2) is a margin of error considering dispersion and an error of the measured value of the ultraviolet absorbance, and is set to 0% to 10%. preferably 3% to 5%. If the UV 254 residual rate A₂₅₄ᵣₑₛᵤₗₜ of the treated water satisfies the range specified by the above Expression (2), the current ozone injection rate is maintained, and processing returns to step S102 and step S105.

On the other hand, if the UV 254 residual rate does not satisfy the range specified by the above Expression (2), processing advances to step S108, and the control unit 10 compares the relationship of the UV 254 residual rate A₂₅₄ᵣₑₛᵤₗₜ and the UV 254 residual rate estimated value A₂₅₄ₑₛₜ, with the following Expression (3).

UV 254 residual rate estimated value A₂₅₄ₑₛₜ>UV 254 residual rate A₂₅₄ᵣₑₛᵤₗₜ±B (3)

If the UV 254 residual rate A₂₅₄ᵣₑₛᵤₗₜ of the treated water satisfies the above Expression (3), processing advances to step S109, and the control unit 10 controls to decrease the ozone injection rate, and if not, processing advances to step S110, and the control unit 10 controls to increase the ozone injection rate.

In this way, the water treatment apparatus according to Embodiment 1 continuously measures the ultraviolet absorbance of the untreated water 3 and the treated water, and controls the ozone injection rate based on these measurement results. In other words, the water treatment apparatus according to Embodiment 1 compares the UV 254 residual rate A₂₅₄ᵣₑₛᵤₗₜ with the UV 254 residual rate estimated value A₂₅₄ₑₛₜ, which was estimated earlier when the retention of the water started in the ozone treatment tank 2 corresponding to the retention time in the ozone treatment tank 2, and the ozone injection rate is controlled based on the comparison result, whereby the ozone injection rate can be controlled appropriately in accordance with the change in the water quality of the untreated water.

Further, the water treatment apparatus according to Embodiment 1 estimates the ozone injection rate that is required for decomposing the organic substances, based on the water quality of the untreated water. Therefore feed forward control to implement the ozone injection rate required for ozone treatment can be performed.

In the case when the inflow quantity of the untreated water 3 changes, the ozone injection rate to the untreated water 3 becomes insufficient if the inflow quantity of the untreated water 3 increases. This means that the UV 254 residual rate A₂₅₄ᵣₑₛᵤₗₜ of the treated water increases, compared with the UV 254 residual rate estimated value A₂₅₄ₑₛₜ estimated based on the UV 210 of the untreated water 3. Therefore in this case, control to increase the ozone injection rate is performed as indicated in step S110.

If the inflow quantity of the untreated water 3 decreases, on the other hand, the ozone injection rate to the untreated water 3 becomes excessive. This means that the UV 254 residual rate A₂₅₄ᵣₑₛᵤₗₜ of the untreated water 3 decreases, compared with the UV 254 residual rate estimated value A₂₅₄ₑₛₜ estimated based on the UV 210 of the untreated water 3. Therefore in this case, control to decrease the ozone injection rate is performed as indicated in step S109. In this way, the water treatment apparatus according to Embodiment 1 can control the ozone injection rate appropriately in accordance with the change in the inflow quantity of the untreated water 3.

Further, as described in prior art, not less than the reference value of the bromate may be generated when the dissolved ozone is detected in a high water temperature period, such as summer time. This generation of the bromate can be suppressed if the ozone injection rate is controlled in accordance with the change in the water quality index within a range of the ozone injection rate where the dissolved ozone is not detected.

In other words, even when the ozone injection rate is in a range where the dissolved ozone is not detected, the ozone injection rate may become insufficient and the decomposition of organic substances, which is the original target of the ozone treatment, may not be implemented if ozone is injected in accordance with the change in the water quality index. This embodiment can prevent such a situation. Furthermore, if the ozone required for decomposing the organic substances is injected in the range of the ozone injection rate by which the dissolved ozone is not detected, an excessive injection of ozone is prevented, and the generation of the bromate can be suppressed.

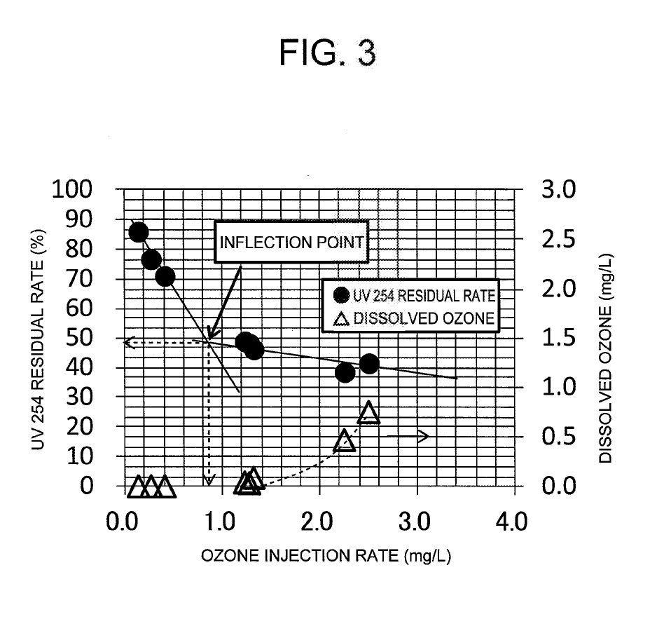

Hence, in order to control the ozone injection rate using the ultraviolet absorbance in the range of the ozone injection rate where the dissolved ozone is not detected, the relationship of the change of the UV 254 residual rate and the dissolved ozone concentration, with respect to the ozone injection rate, was examined based on experiments. For the experiments, three types of untreated water, which came from different sources, were used. The results are depicted in FIG. 3 to FIG. 5.

The following three types of untreated water (1) to (3) were used.

Untreated water (1): untreated water of which source is a river

Untreated water (2): untreated water of which source contains rain and domestic waste water

Untreated water (3): untreated water of which source contains biologically treated water

FIG. 3 is a diagram depicting each relationship of the UV 254 residual rate and the dissolved ozone concentration, to the ozone injection rate when the untreated water (1) is treated with ozone by the water treatment apparatus according to Embodiment 1 of this invention. In FIG. 3, the experiment result of the UV 254 residual rate with respect to the ozone injection rate is plotted with black dots, and the experiment result of the dissolved ozone concentration with respect to the ozone injection rate is plotted with white triangles.

The water temperature of the treated water was set to 30° C., assuming a high water temperature period. As the ozone injection rate increases, the UV 254 residual rate decreases, and the slope of the UV 254 residual rate with respect to the ozone injection rate lessens when the ozone injection rate is 0.8 mg/L or more.

The point at which the slope of the UV 254 residual rate, with respect to the ozone injection rate, lessens, is called an “inflection point” here. The UV 254 residual rate at the inflection point is 48%. The same experiment was performed for the untreated water (2) and the untreated water (3), of which water sources are different from that of the untreated water (1), and the UV 254 residual rate at the inflection point was determined respectively (graphs thereof are omitted).

When the ozone injection rate is the inflection point or less, the organic substances, which easily react with ozone, have completely reacted with ozone, and when the ozone injection rate exceeds the inflection point, organic substances, which react with ozone slowly, has begun to react with ozone. Such an organic substance as THMFP, which reacts with ozone quickly, is sufficiently decomposed if the ozone injection rate at the inflection point is used. Therefore if ozone, corresponding lo the ozone injection rate at the inflection point, is injected into the untreated water 3, such an organic substance as THMFP can be reduced.

On the other hand, the dissolved ozone was detected when the ozone injection rate is 1.2 mg/L or more. As indicated in FIG. 3, the ozone injection rate at the inflection point is lower than the ozone injection rate at which the dissolved ozone was detected. This means that the ozone injection rate can be controlled using the UV 254 residual rate as an index, in the range of the ozone injection rate at which the dissolved ozone was not detected.

Therefore in the range of the ozone injection rate at which the dissolved ozone is not detected, it is necessary to detect the UV 254 residual rate and the ozone injection rate at the inflection point of the untreated water 3, in order to inject the amount of ozone required for decomposing organic substances.

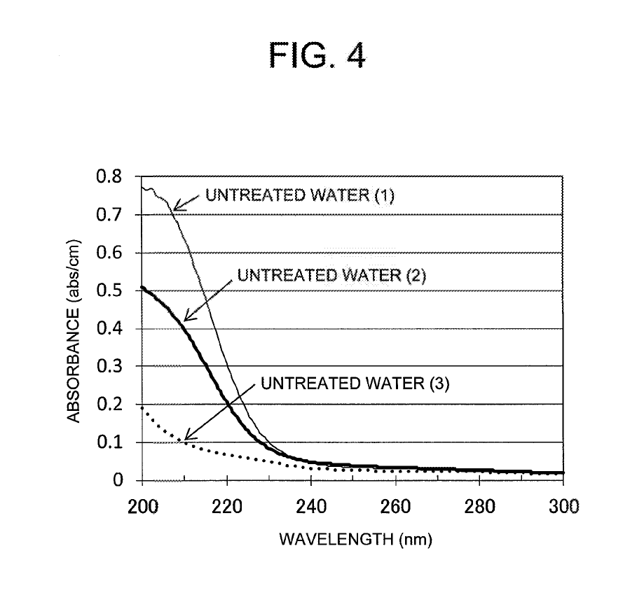

FIG. 4 is a diagram depicting the changes in the absorbance of the three types of untreated water at a 200 nm wavelength to a 300 nm wavelength according to Embodiment 1 of this invention. In any of the untreated water (1) to (3), the absorbance tends to decrease as the wavelength increases. In the wavelength range from 200 nm to 230 nm, the absorbance changes considerably depending on the untreated water. The differences in absorbance in this wavelength range is probably because of the mimic substances contained in the untreated water.

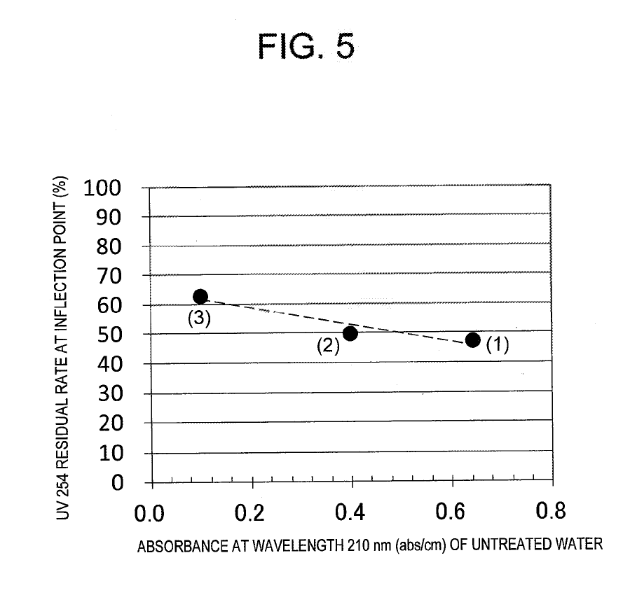

FIG. 5 is a diagram depicting a relationship between the UV 210 of the untreated water and the UV 254 residual rate at the inflection point according to Embodiment 1 of this invention. As the untreated water has a higher absorbance of UV 210, the UV 254 residual rate at the inflection point is lower. In the case of the untreated water (1), of which source is a river, it is likely that the dissolved organic substances are mostly humic substances, such as humic acid and fulvic acid. Such organic substances as humic acid and fulvic acid contain aromatic rings, which probably increases UV 210.

An organic substance containing aromatic rings has a high reactivity with ozone. This is probably the reason why the UV 254 residual rate at the inflection point is low in the untreated water (1), of which ratio of humic substances is high. In the case of the untreated water (2), of which source contains rain and domestic waste water, it is likely that humic substances are less than in untreated water (1), as well as containing surface-active agents and the like.

In the case of the untreated water (3), of which source is biologically treated water, the main dissolved organic substance is probably hydrophilic organic acid. Compared with humic acid, hydrophilic organic acid has a lower absorbance at a 230 nm wavelength or less, and a lower reactivity with ozone. This is probably because in untreated water (3) in which the ratio of the hydrophilic organic acid is high, the UV 254 residual rate at the inflection point is high.

The relationship between the UV 210 of the untreated water and the UV 254 residual rate at the inflection point can be approximated by the following Expression (4), which is a linear equation indicated by the dotted line in FIG. 5.

UV 254 residual rate at inflection point =33.6×UV 210+67.94 (4)

Hence by using the linear approximation in the above Expression (4), the UV 254 residual rate at the inflection point can be estimated from the UV 210 of the untreated water, and the UV 254 residual rate estimated value A₂₅₄ₑₛₜ of the treated water can be set as the target value. This processing corresponds to the processing in step S105 and step S106 in FIG. 2.

As described above, the water treatment apparatus according to Embodiment 1 is configured to estimate the UV 254 residual rate of the treated water from on the UV 210 of the untreated water measured by the ultraviolet absorbance measuring instrument, and control the ozone injection rate so as to minimize the difference between this estimated value and the UV 254 residual rate. As a result, the ozone injection rate can be controlled to an optimum value based on the UV 210 of the untreated water. Therefore the ozone injection rate can be set appropriately in accordance with the water quality of the untreated water and the change in the flow rate thereof.

### Embodiment 2

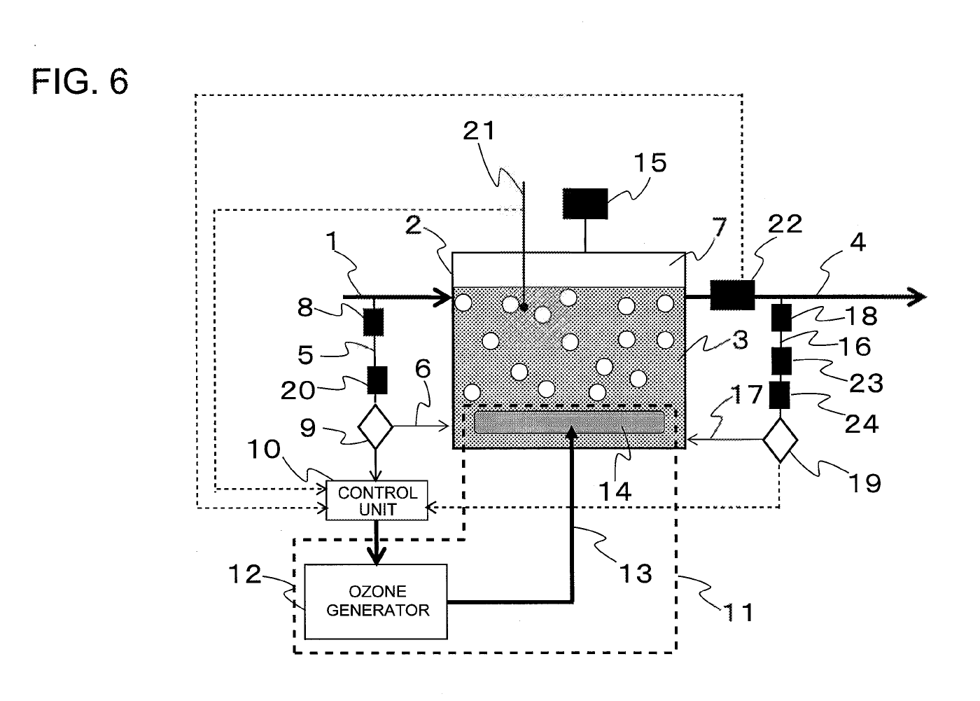

FIG. 6 is a diagram depicting a configuration of a water treatment apparatus according to Embodiment 2 of this invention. The water treatment apparatus of Embodiment 2 is characterized by the addition of a first pH adjuster 20, a water thermometer 21, a first dissolved ozone concentration meter 22, a first aerator 23, and a second pH adjustor 24.

A first untreated water branch pipe 5 is connected to an untreated water pipe 1 of the water treatment apparatus, and is connected to a first ultraviolet absorbance measuring instrument 9 via a first suspended substance eliminator 8. The first pH adjustor 20 is disposed between the first suspended substance eliminator 8 and the first ultraviolet absorbance measuring instrument 9. A second untreated water branch pipe 6, which extends from the first ultraviolet absorbance measuring instrument 9, is connected to an ozone treatment tank 2.

The water thermometer 21 is disposed in the ozone treatment tank 2. The water thermometer 21 may be disposed in the untreated water pipe 1, the first untreated water branch pipe 5, the second untreated water branch pipe 6, a treated water pipe 4, a first treated water branch pipe 16, or a second treated water branch pipe 17.

The first treated water branch pipe 16 is connected to the treated water pipe 4 via the first dissolved ozone concentration meter 22. The first treated water branch pipe 16 is connected to a second ultraviolet absorbance measuring instrument 19 via a second suspended substance eliminator 18 and the first aerator 23. Further, the second pH adjuster 24 is disposed between the first aerator 23 and the second ultraviolet absorbance measuring instrument 19. The second treated water branch pipe 17, which extends from the second ultraviolet absorbance measuring instrument 19, is connected to the ozone treatment tank 2.

The first dissolved ozone concentration meter 22 may be disposed in a position near the treated water exit inside the ozone treatment tank 2, a position in a subsequent stage of the connection portion between the treated water pipe 4 and the first treated water branch pipe 16, or a position in a preceding stage of the second suspended substance eliminator 18 of the first treated water branch pipe 16. Or the first dissolved ozone concentration meter 22 may be configured to measure the dissolved ozone concentration of the untreated water 3 in the ozone treatment tank 2.

Further, in the water treatment apparatus according to Embodiment 2, the measured values measured by the water thermometer 21 and the first dissolved ozone concentration meter 22 are sent to the control unit 10.

In Embodiment 2, the second untreated water branch pipe 6 and the second treated water branch pipe 17 are connected to the ozone treatment tank 2. By this configuration, the untreated water 3, into which the ozone was injected, can flow backward, cleaning the first ultraviolet absorbance measuring instrument 9 and the second ultraviolet absorbance measuring instrument 19. The water treatment apparatus of Embodiment 2 may be configured to inject ozone gas into the first untreated water branch pipe 5 or the second treated water branch pipe 17. Then contamination of the ultraviolet absorbance measuring instruments 9 and 19 can be removed, and the measurement accuracy of the ultraviolet absorbance measuring instruments 9 and 19 can be maintained.

The first pH adjustor 20 has a function to adjust the pH of the untreated water 3 to a predetermined pH by adding acid or alkali to the untreated water 3. Thereby the pH of the untreated water 3, measured by the first ultraviolet absorbance measuring instrument 9, can be adjusted to 6.5 to 8.5, preferably 7.4 to 7.8.

The reason why the pH of the untreated water is adjusted is because the absorbances of a substituent group and a functional group of a dissolved organic substance may be changed by a change in the ionization ratio depending on the pH. Therefore if the first pH adjuster 20 is included, the ultraviolet absorbance measurement accuracy improves, and the ozone injection rate can be controlled more appropriately.

Just like the first pH adjustor, the second pH adjustor 24 has a function to adjust the pH of the treated water to a predetermined value. As a result, the ultraviolet absorbance measurement accuracy of the treated water improves, and the ozone injection rate can be controlled more appropriately.

By disposing the first aerator 23 in the preceding stage of the second ultraviolet absorbance measuring instrument 19, the ozone dissolved in the treated water can be eliminated. The ozone is absorbed at a 254 nm wavelength, hence if ozone remains in the treated water, the UV 254 residual rate of the treated water has a plus error. Therefore by aerating the treated water and eliminating the dissolved ozone, the accuracy of measuring the UV 254 residual rate of the treated water can be improved.

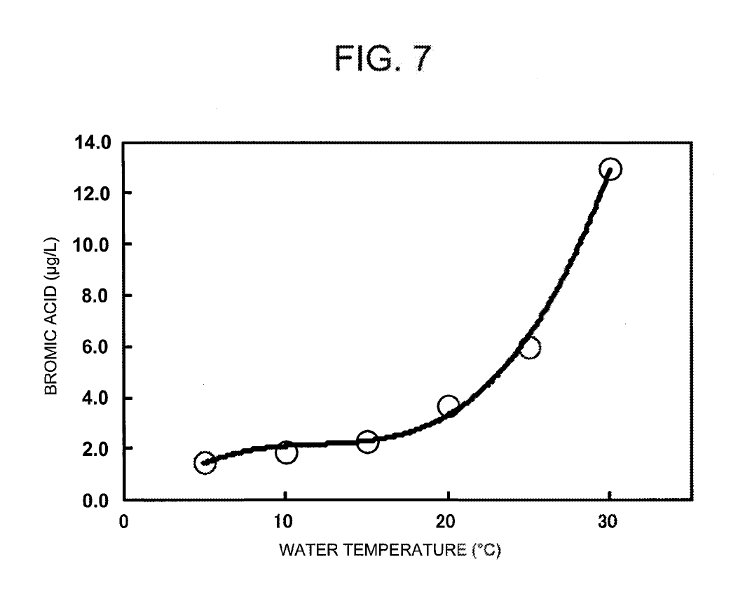

FIG. 7 is a diagram depicting a relationship of the generation amount of bromate with the water temperature of the untreated water 3 according to Embodiment 2 of this invention. The generation amount of the bromate indicated in FIG. 7 is a value when the product of the dissolved ozone concentration and time is 10 mg/L·min⁻¹. Pure water was used for the untreated water 3.

As depicted in FIG. 7, in the water temperature range of 10° C. to 30° C. the generation amount of the bromate tends to increase when the water temperature is 20° C. or more, and the generation amount of the bromate rapidly increases when the water temperature becomes 25° C. or more. Therefore when the water temperature is 25° C. or more, ozone treatment is performed in a range of the ozone injection rate at which dissolved ozone is not detected. Thereby the organic substances can be decomposed, and the generation of bromate can be suppressed.

When the water temperature is less than 10° C., the generation amount of the bromate tends to decrease as depicted in FIG. 7. However if dissolved ozone concentration is controlled when the water temperature is low, the generation amount of the bromate is low even if dissolved ozone is detected, but an odorous substance, such as mold, cannot be sufficiently decomposed. Hence in the low-water temperature period, such as when the water temperature is 10° C. or less, the ozone treatment is performed based on the UV 254 residual rate, including the range of the ozone injection rate at which dissolved ozone is detected.

When the ozone treatment is performed in the range of the ozone injection rate at which the dissolved ozone is detected, the ultraviolet absorbance measurement accuracy, by the second ultraviolet absorbance measuring instrument 19, can be improved if the dissolved ozone is eliminated from the treated water, using the first aerator 23 disposed in a preceding stage of the second ultraviolet absorbance measuring instrument 19.

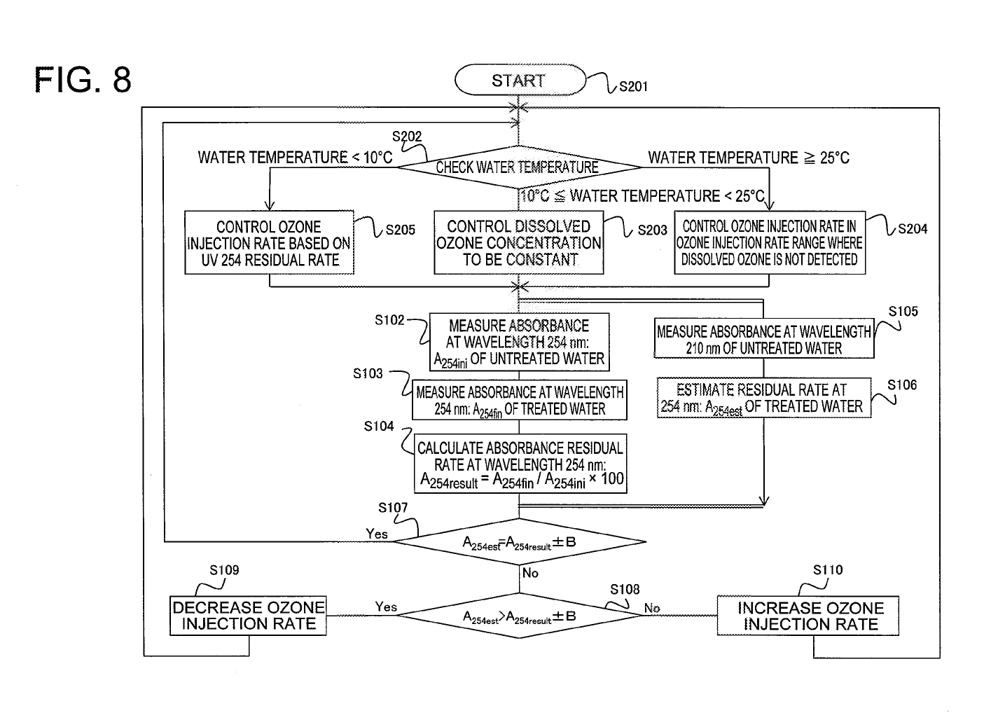

FIG. 8 is a flow chart depicting a serious of operations of the water treatment method performed by the water treatment apparatus according to Embodiment 2 of this invention. In the flow chart in FIG. 8 according to Embodiment 2, compared with the above mentioned flow chart in FIG. 2 according to Embodiment 1. step S202 to step S205 are added, which is a differentiation, and step S102 to step S110 remain the same. These added steps will be primarily described below.

In step S201 of the flow chart in FIG. 8, it is assumed that the untreated water 3 is contained in the ozone treatment tank 2, and the water treatment method of Embodiment 2 is started in a state where the ozone treatment is performed for the untreated water 3.

In step S202, the control unit 10 reads the measured value of the water thermometer 21, and processing advances to one of the following three cases depending on the measured value. Case 1 is when the water temperature of the untreated water 3 is 10° C. or more and less than 25° C., and in this case processing advances to step S203, where the control unit 10 executes the dissolved ozone concentration constant control method. Processing then advances to step S102.

Case 2 is when the water temperature of the untreated water 3 is 25° C. or more, and in this case, processing advances to step S204, where the control unit 10 controls the ozone injection rate in a range of ozone injection rate at which residual ozone is not detected in the untreated water 3. In other words, the control unit 10 controls the ozone injection rate such that the dissolved ozone concentration becomes the detection lower limit value by the first dissolved ozone concentration meter 22 or less. Processing then advances to step S102.

Case 3 is when the water temperature of the untreated water 3 is less than 10° C., and in this case, processing advances to step S205, where the control unit 10 substitutes the measured value of the first dissolved ozone concentration meter 22 for the above Expression (4), so that the UV 254 residual rate at the inflection point is estimated, and the ozone injection rate is controlled based on the estimated UV 254 residual rate. Processing then advances to step S102.

In this way, the water treatment apparatus according to Embodiment 2 can perform the ozone injection control appropriately based on the respective measured values by the water thermometer 21 and the first dissolved ozone concentration meter 22.

As described above, the water treatment apparatus according to Embodiment 2 switches between the dissolved ozone concentration constant control method and the ozone injection rate control method based on the ultraviolet absorbance, depending on the water temperature of the untreated water. Further, by including a means of aerating the untreated water in a preceding stage of the second ultraviolet absorbance measuring instrument, the ozone remaining in the untreated wafer can be eliminated, and therefore the ultraviolet absorbance can be measured more accurately.

Further, the measurement accuracy can be improved by measuring the ultraviolet absorbance alter adjusting the pH of the untreated water and the treated Water to predetermined values. By including this configuration, an optimum ozone injection rate can be implemented in accordance with the water temperature, the water quality and the change in flow rate of the untreated water.

### Embodiment 3

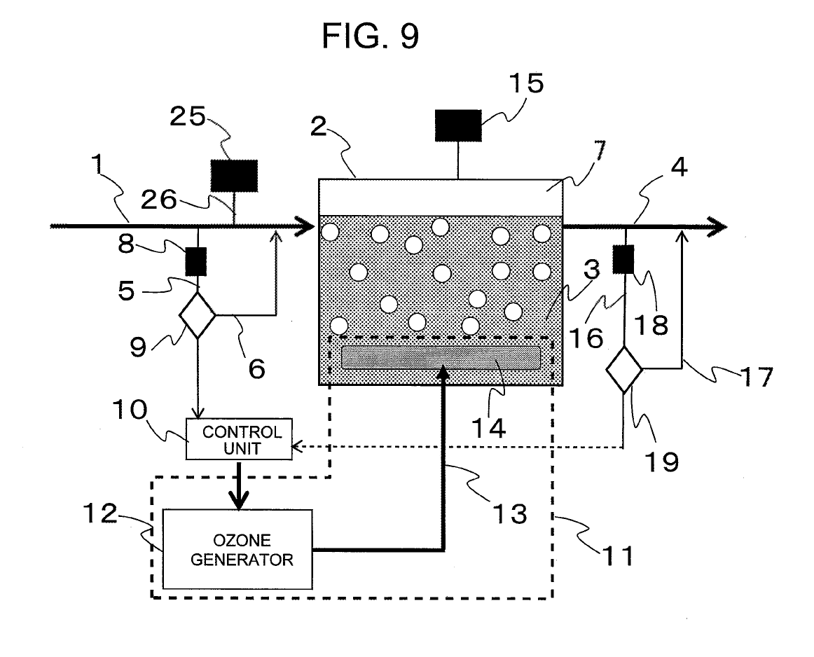

FIG. 9 is a diagram depicting a configuration of a water treatment apparatus according to Embodiment 3 of this invention. The water treatment apparatus of Embodiment 3 is characterized by the addition of a compact water treatment apparatus 25. The compact water treatment apparatus 25 can determine the UV 254 residual rate at the inflection point in real-time.

The compact water treatment apparatus 25 is connected to an untreated water pipe 1 via a third untreated water branch pipe 26. The compact water treatment apparatus 25 may be connected to a first untreated water branch pipe 5 or a second untreated water branch pipe 6.

The first untreated water branch pipe 5 is connected to the untreated water pipe 1 of the water treatment apparatus, and the first untreated water branch pipe 5 is connected to a first ultraviolet absorbance measuring instalment 9 via a first suspended substance eliminator 8. The second untreated water branch pipe 6, which extends from the first ultraviolet absorbance measuring instrument 9, is connected to the untreated water pipe 1 disposed in the subsequent stage of the branch point between the untreated water pipe 1 and the first untreated water branch pipe 5.

On the other hand, a first treated water branch pipe 16 is connected to a treated water pipe 4, and the first heated water branch pipe 16 is connected to a second ultraviolet absorbance measuring instrument 19 via a second suspended substance eliminator 18. A second treated water branch pipe 17, which extends from the second ultraviolet absorbance measuring instrument 19, is connected to the treated water pipe 4 disposed in the subsequent stage of the branch point between the treated water pipe 4 and the first treated water branch pipe 16.

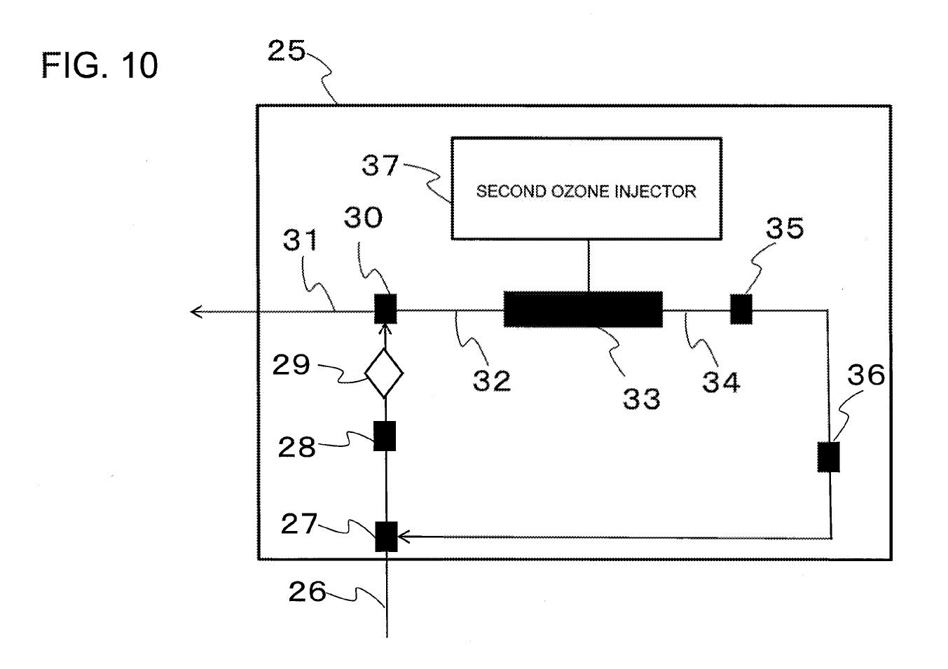

FIG. 10 is a diagram depicting a configuration of the compact water treatment apparatus 25 according to Embodiment 3 of this invention. The third untreated water branch pipe 26 is connected to a third suspended substance eliminator 28 via a first selector valve 27. A second selector valve 30 is connected in the subsequent stage of the third suspended substance eliminator 28 via a third ultraviolet absorbance measuring instalment 29. A fourth untreated water branch pipe 31 and a fifth untreated water branch pipe 32 are connected to the second selector valve 30.

A treatment tank 33 is connected to the fifth untreated water branch pipe 32. A third treated water branch pipe 34, which extends from the treatment tank 33, is connected to a second aerator 36 via a second dissolved ozone concentration meter 35, and is connected to the first selector valve 27 disposed in the subsequent stage of the second aerator 36.

A second ozone injector 37 is connected to the treatment tank 33. Instead of the ozone gas generated by the second ozone injector 37, the ozone gas that branches from a first ozone injector 11 may be used.

The compact water treatment apparatus 25 introduces the untreated water 3 via the third untreated water branch pipe 26, and starts ozone treatment. First, to measure the UV 254 of the untreated water 3, the first selector valve 27 is opened in the direction of the third suspended substance eliminator 28, and the suspended substances in the untreated water 3 are eliminated. The third ultraviolet absorbance measuring instrument 29 measures the UV 254 of the untreated water that passed through the third suspended substance eliminator 28.

If the second selector valve 30 is opened in the direction of the treatment tank 33 after the measurement, the untreated water 3 is introduced into the treatment tank 33. Ozone is injected into this untreated water 3 in the treatment tank 33 from the second ozone injector 37 at an arbitrary injection rate.

After a predetermined time has elapsed, the dissolved ozone concentration in the treated water is measured using a second dissolved ozone concentration meter 35, and the dissolved ozone concentration with respect to the ozone injection rate is determined. The dissolved ozone in the treated water is eliminated using the second aerator 36. The treated water after eliminating the dissolved ozone is introduced into the third ultraviolet absorbance measuring instrument 29 via the first selector valve 27. Then the third ultraviolet absorbance measuring instrument 29 measures the UV 254 of the ozone treated water, and determines the UV 254 residual rate with respect to the ozone injection rate.

The compact water treatment apparatus 25 according to Embodiment 3 determines the UV 254 residual rate and the dissolved ozone concentration with respect to an arbitrary ozone injection rate at one or more points respectively. Thereby the relationship of the UV 254 residual rate and the dissolved ozone concentration, with respect to the ozone injection rate, as depicted in FIG. 3, can be determined.

As described above, the setting accuracy of the target value of the ozone injection rate can be improved by determining the UV 254 residual rate in real-time, in parallel with the ozone water treatment, using the compact water treatment apparatus 25.

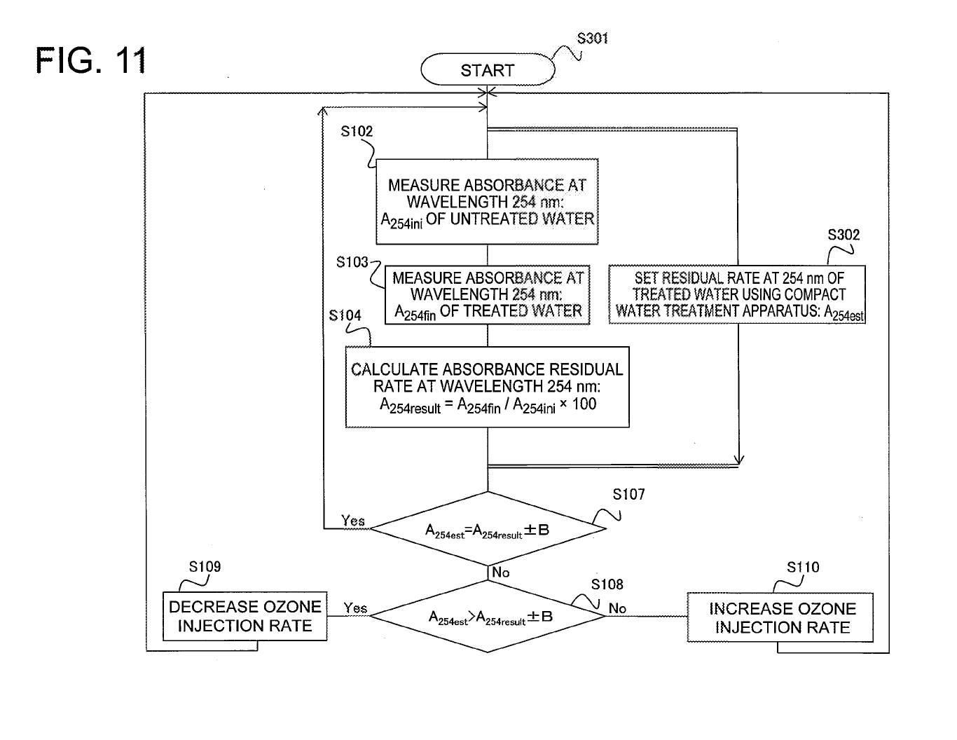

FIG. 11 is a flow chart depicting a series of operations of the water treatment method performed by the water treatment apparatus according to Embodiment 3 of this invention. In the flow chart in FIG. 11 according to Embodiment 3, compared with the above mentioned flow chart in FIG. 2 according to Embodiment 1, step S302 is used instead of step S105 and step S106, which is a differentiation, and the other steps remain the same. Therefore step S302 will be primarily described below.

In step S301 of the flow chart in FIG. 11, it is assumed that the untreated water 3 is contained in the ozone treatment tank 2, and the water treatment method of Embodiment 3 is started in a state where the ozone treatment is performed for the untreated water 3.

In the water treatment method of Embodiment 3, essentially the same operations as in the series of operations of Embodiment 1, which was described above with reference to FIG. 2, are performed. However in Embodiment 3, the UV 254 residual rate estimated value A₂₅₄ₑₛₜ of the treated water is calculated in real-time in step S302 using the compact water treatment apparatus 25, instead of being estimated from the UV 210 of the untreated water.

As described above, the water treatment apparatus according to Embodiment 3 is configured to determine the UV 254 residual rate at the inflection point of the untreated water in real-time using the compact water treatment apparatus 25. As a result, the ozone injection rate can be controlled more appropriately in accordance with the change in the water quality of the untreated water.

### Embodiment 4

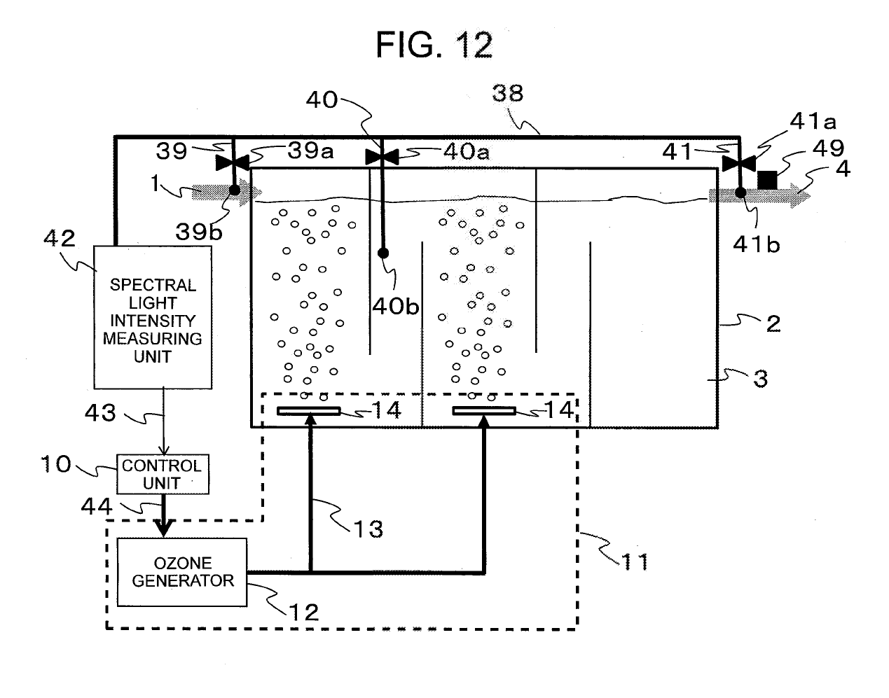

FIG. 12 is a diagram depicting a configuration of a water treatment apparatus according to Embodiment 4 of this invention. The water treatment apparatus of Embodiment 4 is characterized by measuring the spectral light intensity in at least three locations (the entrance and exit of the ozone treatment tank 2, and at one or more locations there between). A case when ozone gas is injected into a first tank and a second tank of a multi-stage ozone treatment 2 will be described below as an example.

In FIG. 12, three pipes that branch from a water branch pipe 38 (first branch pipe 39, second branch pipe 40, and third branch pipe 41) are depicted. The first branch pipe 39 is connected to an untreated water pipe 1 of an ozone treatment tank 2. The second branch pipe 40 is connected so as to extend into the untreated water 3 at an intermediate point in the ozone treatment tank 2, and the third branch pipe 41 is connected to a treated water pipe 4. A first valve 39a, a second value 40a and a third valve 41a are disposed in the first branch pipe 39, the second branch pipe 40 and the third branch pipe 41 respectively.

The water branch pipe 38 is connected to a spectral light intensity measuring unit 42. The measured value by the spectral light intensity measuring unit 42 is sent to a control unit 10 via a cable 43. The control unit 10 is connected to a first ozone injector 11 via a cable 44. An ozone gas diffuser pipe 14 of the first ozone injector 11 is disposed at the bottom of the first tank and the second tank of the ozone treatment tank 2 respectively.

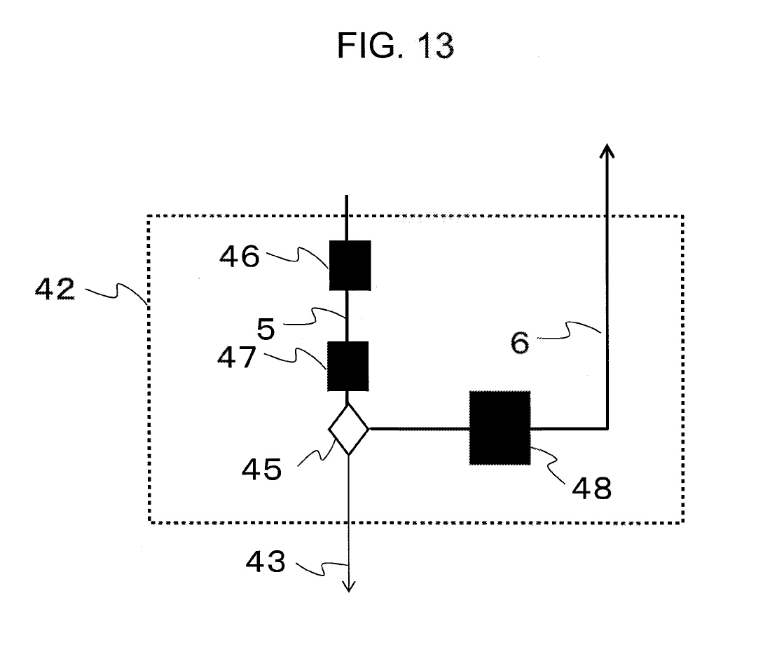

FIG. 13 is a diagram depicting the configuration of the spectral light intensity measuring unit 42 according to Embodiment 4. The spectral light intensity measuring unit 42 is constituted by a fourth ultraviolet absorbance measuring instrument 45, a fourth suspended substance eliminator 46, a fourth aerator 47, and a water absorption pump 48. A first fluorescence intensity measuring instrument may be used instead of the fourth ultraviolet absorbance measuring instrument 45.

The tips of the first branch pipe 39, the second branch pipe 40, and the third branch pipe 41 are disposed in the untreated water 3 in the ozone treatment tank 2, where a first measurement location 39b, a second measurement location 40b and a third measurement location 41b are set respectively. The untreated water 3 in each of the measurement locations 39b to 41b is sent to the spectral light intensity measuring unit 42 by a function of the water absorption pump 48 when one of the valves 39a to 41a, disposed in each pipe connected to each measurement location, is opened.

In the spectral light intensity measuring unit 42, suspended substances in the untreated water 3 are eliminated by the fourth suspended substance eliminator 46, and the dissolved ozone is eliminated by the fourth aerator 47. Then the absorbance (UV 254) of the untreated water 3 is measured by the fourth ultraviolet absorbance measuring instrument 45. In the third measurement location 41b, the dissolved ozone may be measured by disposing a dissolved ozone concentration meter 49.

Alternatively the dissolved ozone concentration may also be determined as follows. After eliminating the suspended substances in the untreated water 3 sampled in the third measurement location 41b, UV 254 is measured for the first time in a preceding stage of aeration. Then the untreated water 3, after the first UV 254 measurement, is aerated, and the dissolved ozone is eliminated, next UV 254 is measured for the second time using the fourth ultraviolet absorbance measuring instrument 45.

Then the dissolved ozone concentration is determined from the difference between the UV 254 measured value for the first time and that for the second time. In the case of the latter, the dissolved ozone concentration can be measured without installing the dissolved ozone concentration meter 49, and the configuration of the apparatus can be simplified.

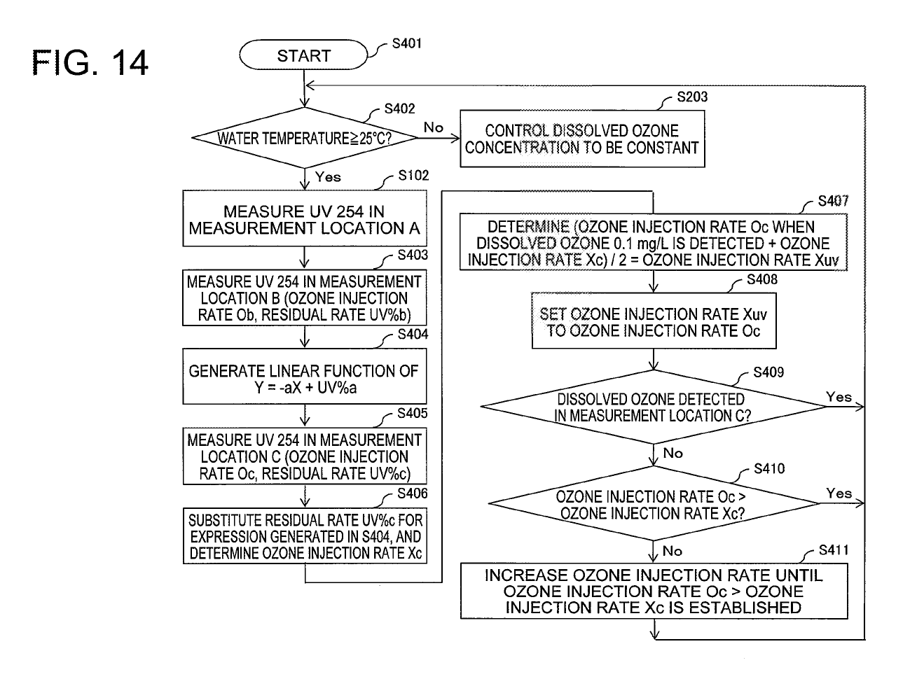

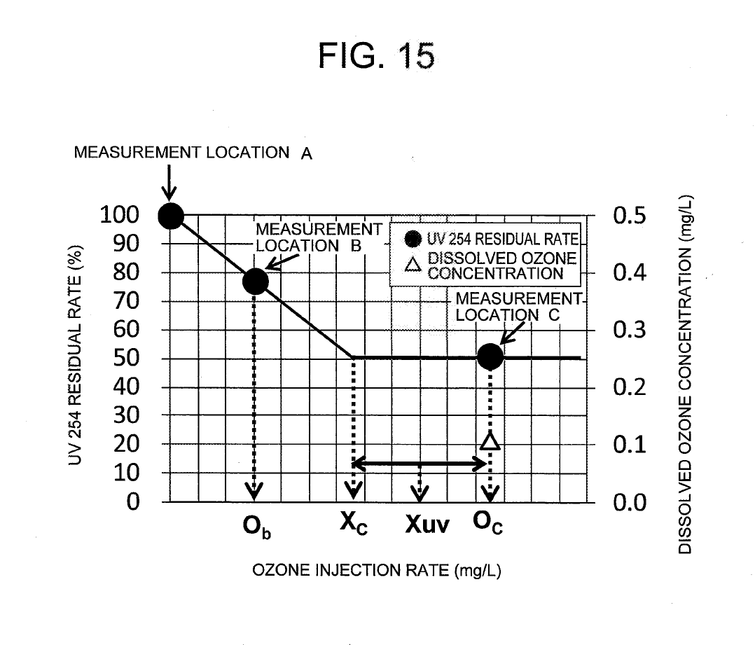

FIG. 14 is a flow chart depicting a series of operations of the water treatment method performed by the water treatment apparatus according to Embodiment 4 of this invention. FIG. 15 is a diagram of an experiment result depicting each relationship of the UV 254 residual rate and the dissolved ozone concentration, with the ozone injection rate, when the untreated water 3 is treated with ozone by the water treatment apparatus according to Embodiment 4 of this invention.

In FIG. 15, the UV 254 residual rate with respect to the ozone injection rate is plotted with black dots, and the dissolved ozone concentration with respect to the ozone injection rate is plotted with white triangles. The water treatment method of Embodiment 4 will be described in detail with reference to FIG. 14 and FIG. 15.

Step S102 in FIG. 14 according to Embodiment 4 is the same as the above mentioned step S102 in FIG. 2 according to Embodiment 1. And step S203 in FIG. 14 according to Embodiment 4 is the same as the above mentioned slop S203 in FIG. 8 according to Embodiment 2. Therefore the steps added in Embodiment 4 will be primarily described below.

In step S401 of the flow chart in FIG. 14, it is assumed that the untreated water 3 is contained in the ozone treatment tank 2, and the water treatment method of Embodiment 4 is started in a state where the ozone treatment is performed for the untreated water 3.

Therefore the following description concerns the state after the dissolved ozone concentration constant control method has just switched to the water treatment method of Embodiment 4. Here it is assumed that the water treatment method of Embodiment 4 is started in a state where dissolved ozone is detected in the ozone treated water.

In step S402, the control unit 10 starts the water treatment method of Embodiment 4 when the water temperature is a predetermined temperature or more. In the case of a high water temperature period, such as summer time, the generation of bromate may increase even if the dissolved ozone is not detected. In the following description it is assumed that the predetermined temperature is a water temperature of 25° C. or more. A case of measuring the absorbance at a 254 nm wavelength (UV 254), using the ultraviolet absorbance measuring instrument 45, will be described as an example.

The spectral light intensity measuring unit 42 according to Embodiment 4 measures the absorbance at a 254 nm wavelength in three or more locations in the ozone treatment tank 2. Here the measurement locations are assumed to be the first measurement location 39b at the entrance of the ozone treatment tank 2, the second measurement location 40b in an intermediate position in the ozone treatment tank 2, and the third measurement location 40c at the exit of the ozone treatment tank 2. In the following description, the first measurement location 39b is called the measurement location A, the second measurement location 40b is called the measurement location B, and the third measurement location 41b is called the measurement location C.

The UV 254 is measured in the measurement locations A, B and C, and the UV 254 residual rate in each location is assumed to be UV%a, UV%b and UV%c respectively.

When the water temperature is 25° C. or more, processing advances to step S102, where the fourth ultraviolet absorbance measuring instrument 45 measures UV 254 for the untreated water 3 after the suspended substances are eliminated in the measurement location A, then processing advances to step S403. When the water temperature is less than 25° C., processing advances to step S203, where the control unit 10 executes the dissolved ozone concentration constant control method, just like the above mentioned step S203 in FIG. 8.

In step S403, the fourth ultraviolet absorbance measuring instrument 45 measures the ozone injection rate Ob and UV245b in the intermediate location B in the ozone treatment tank 2, and calculates the residual rate UV%b.

In step S404, the control unit 10 creates the change curve, where the ozone injection rate is X and the UV 254 residual rate is Y, by the linear function in the following Expression (5), using the measurement results of the ozone injection rates at the measurement locations A and B respectively and the calculation result of the residual rate.

Y=−aX+UV%a (5)

Further, in step S405, the fourth ultraviolet absorbance measuring instrument 45 measures the ozone injection rate Oc and the UV 254c in the measurement location C, and calculates the residual rate UV%c. Then in step S406, the control unit 10 substitutes UV%c for the dependent variable Y of the linear function generated in step S404, and determines the ozone injection rate Xc as the independent variable X.

Then in step S407, the control unit 10 determines the ozone injection rate Xuv using the following Expression (6).

(Ozone injection rate Oc when dissolved ozone 0.1 mg/L was detected+ozone injection rate Xc)/2=ozone injection rate Xuv (6)

For the ozone injection rate Oc when the dissolved ozone 0.1 mg/L was detected in the above Expression (6), the ozone injection rate used for the ozone injection rate constant control method, which was executed until the control is switched to the control method of Embodiment 4, can be used.

In other words, in the case of the ozone injection rate constant control method, the ozone injection rate is controlled such that 0.1 mg/L of the dissolved ozone is detected in the ozone treated water. Therefore after the control is switched to the control method of Embodiment 4, the ozone injection rate, which was used in the ozone injection rate constant control method, can be used as the ozone injection rate Oc.

Then in step S408, the control unit 10 sets the ozone injection rate Xuv to the ozone injection rate Oc, and continues the water treatment of Embodiment 4. Then in step S409, the control unit 10 measures the dissolved ozone concentration in the measurement location C, and determines whether dissolved ozone is detected.

When the dissolved ozone is detected, processing advances to step S402, and the control unit 10 repeatedly executes control of the ozone injection rate according to Embodiment 4. When the dissolved ozone is not detected, processing advances to step S410, and the control unit 10 determines whether the relationship of the following Expression (7) is established between the ozone injection rate Oc and the ozone injection rate Xc.

Ozone injection rate Oc>ozone injection rate Xc (7)

When the ozone injection rate Oc satisfies the above Expression (7), the control unit 10 returns to step S402, and repeatedly executes the control of the ozone injection rate according to Embodiment 4. When the ozone injection rate Oc does not satisfy the above Expression (7). processing advances to step S411, and the control unit 10 increases the ozone injection rate until the above Expression (7) is satisfied.

If the water treatment is performed continuously, the water quality and the inflow quantity of the untreated water 3 change. Therefore when the dissolved ozone is detected (when the result of step S409 is YES), or when the relationship of ozone injection rate Oc>ozone injection rate Xc of the above Expression (7) is established (when the result of step S410 is YES), the control unit 10 executes control at each predetermined time so as to maintain the current ozone injection rate.

The water treatment apparatus according to Embodiment 4 measures the UV 254 in at least three locations (the entrance and exit of the ozone treatment tank 2 and one or more intermediate points there between), and a relational expression is generated based on these measurement results, whereby the ozone injection rate is controlled.

In other words, the water treatment apparatus according to Embodiment 4 estimates an ozone injection rate, at which the slope of the UV 254 residual rate with respect to the ozone injection rate lessens using the above Expressions (5) to (7), and controls the ozone injection rate targeting this estimated ozone injection rate.

As depicted in FIG. 15, in a high water temperature period, such as summer time, an inflection point at which the slope of the UV 254 residual rate with respect to the ozone injection rate lessens, as depicted in FIG. 3, exists in the range of the ozone injection rate at which dissolved ozone is not detected. Therefore in such a high temperature period as summer time, the ozone injection rate is controlled using the UV 254 residual rate as an index, then the amount of ozone required for decomposing organic substances can be injected into the untreated water, regardless whether the dissolved ozone is detected.

In the measurement location A, which is at the entrance of the reaction tank, the ozone injection rate is 0 mg/L and the UV 254 residual rate is 100%. Therefore the control unit 10 generates the above Expression (5) using the UV 254 residual rates in the measurement locations A and B, where the UV 254 residual rate decreases with respect to the ozone injection rate. Further, the control unit 10 substitutes UV%c in the measurement location C for Y of the above Expression (5), and determines the ozone injection rate Xc. The method for calculating the ozone injection rate using these values will be described below.

When the water temperature rises to 25° C. or more, the control unit 10 switches the index to control the ozone injection rate from the dissolved ozone concentration to the UV 254 residual rate. Then the control unit 10 sets the ozone injection rate Xuv by (Xc+Oc)/2 (corresponds to the above Expression (6)) using the ozone injection rate immediately before the switching, that is, the ozone injection rate Oc at which the dissolved ozone 0.1 mg/L was detected. Then the control unit 10 controls the ozone injection rate according to Embodiment 4, targeting the ozone injection rate Xuv.

In the case when the dissolved ozone is detected in the measurement location C, which means that the ozone injection rate is too high, the ozone injection rate is set using the same procedure as the procedure immediately after the control method is switched from the dissolved ozone concentration control to the ozone injection rate control of Embodiment 4.

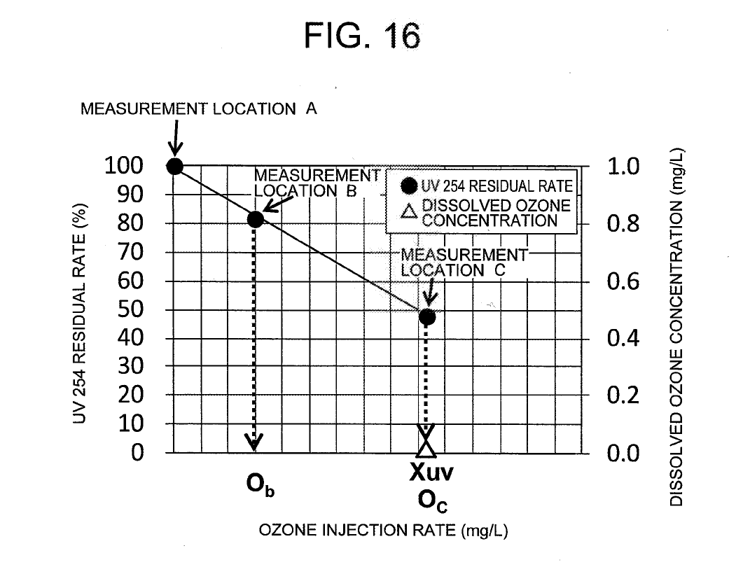

FIG. 16 is a diagram depicting each relationship of the UV 254 residual rate and the dissolved ozone concentration, with the ozone injection rate when the untreated water 3 is treated with ozone by the water treatment apparatus according to Embodiment 4 of this invention and the ozone injection rate at this time is insufficient.

In FIG. 16, the experiment result of the UV 254 residual rate with respect to the ozone injection rate is plotted with black dots, and the experiment result of the dissolved ozone concentration with respect to the ozone injection rate is plotted with white triangles.

When the ozone injection rate Oc and the ozone injection rate Xc are the same, that is, when UV%c in the measurement location C is on the line of the linear function of the above Expression (5), the ozone injection rate is insufficient. Therefore the control unit 10 increases the ozone injection rate until the relationship of ozone injection rate Oc>ozone injection rate Xc is established.

In the description on the water treatment according to Embodiment 4, the ultraviolet absorbance measuring instrument 45 is used for the spectral light intensity measuring unit 42 as an example, but a fluorescence intensity measuring instrument may be used for the spectral light intensity measuring unit. In the case of using the fluorescence intensity measuring unit, the fluorescence at any wavelength in a 400 nm to 460 nm range is measured by exciting the untreated water using the light at any wavelength in a 200 nm to 370 nm range which has high correlation with the humic substances in the untreated water.

Preferably the fluorescence at a 450 nm wavelength is measured by exciting the untreated water using the light at a 260 nm wavelength. It is known that the fluorescence intensity is quenched by dissolved oxygen, temperature, concentration and coexisting substances. Therefore when the water treatment according to Embodiment 4 is performed using fluorescence intensity, a predetermined concentration of a fluorescent substance is added to the measurement sample, and the measured value is evaluated as a relative value with respect to the fluorescence intensity of the added fluorescent substance.

The fluorescent substance is added to the treated water after the treated water is aerated and dissolved ozone is eliminated. The fluorescence intensity measurement, which is highly correlated to humic substances, is not affected by dissolved ozone. However, if dissolve ozone remains in the treated water, the fluorescent substance added to the ozone treated water may be decomposed by ozone.

Therefore the fluorescent substance is added to the ozone treated water after dissolved ozone is eliminated from the ozone treated water by aeration. Thereby decomposition of the fluorescent substance by ozone can be prevented. Further, the accuracy of the relative evaluation of the fluorescence intensity can be increased if suspended substances are eliminated before measuring the fluorescence intensity.

The water treatment apparatus according to Embodiment 4 measures the fluorescence intensity in each measurement location A to C, calculates the relative fluorescence intensity in each measurement location, then estimates the ozone injection rate at which the slope of the residual rate of the relative fluorescence intensity with respect to the ozone injection rate lessens, using the same method as the case of using UV 254. Then the control unit 10 controls the ozone injection rate targeting this estimated ozone injection rate.

As described above, the water treatment method according to Embodiment 4 uses a configuration to measure the ultraviolet absorbance or the fluorescence intensity at a wavelength that is correlated to the organic substance concentration, in a plurality of locations in the ozone treatment tank 2. Therefore the ozone injection rate can be controlled in accordance with the water quality of the untreated water in a range of ozone injection rate at which dissolved ozone is not detected. Furthermore, the generation of bromate, which is a by-product, can be suppressed while decomposing the organic substances in the untreated water.

Moreover, the ozone injection rate can be controlled in accordance with the change in water quality and the change in water quantity, by switching the dissolved ozone concentration constant control method and the ozone injection rate control method according to Embodiment 4 depending on whether the water temperature of the untreated water is a predetermined temperature or more.

### Embodiment 5

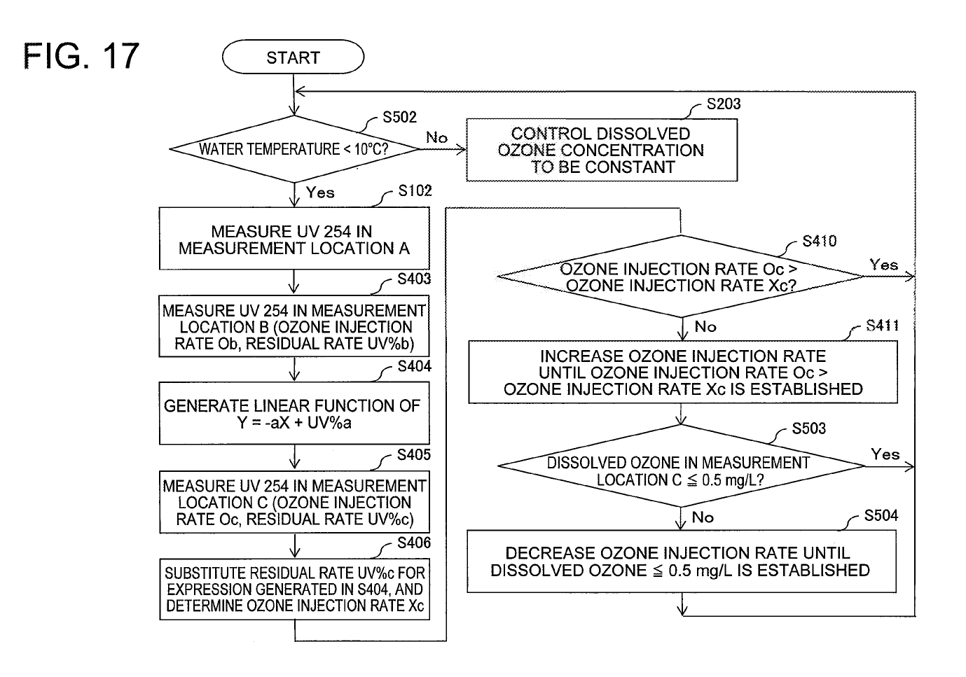

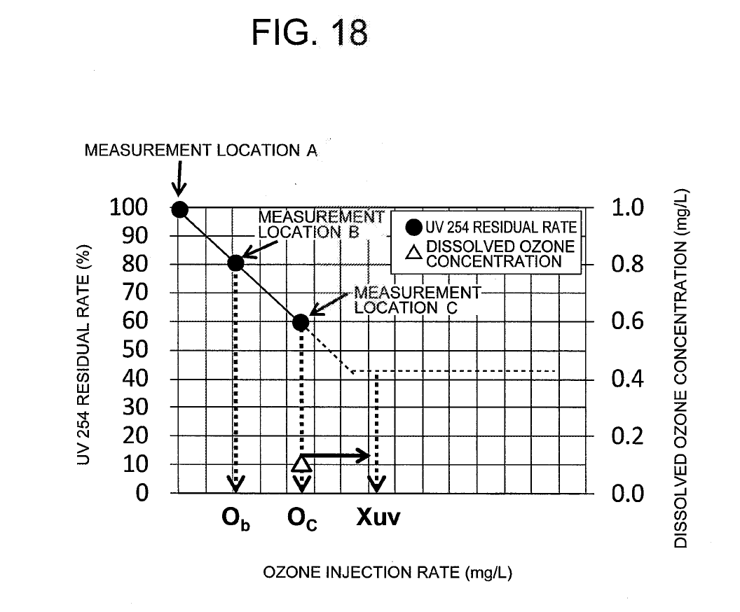

In Embodiment 5, the ozone injection rate control in the case when water temperature is a predetermined temperature or less will be described. FIG. 17 is a flow chart depicting a series of operations of the water treatment method performed by the water treatment apparatus according to Embodiment 5 of this invention. FIG. 18 is a diagram depicting the changes in the UV 254 residual rate and the dissolved ozone with respect to the ozone injection rate respectively when the untreated water 3 is treated with ozone at a predetermined water temperature or less, using the water treatment method according to Embodiment 5 of this invention.

Embodiment 5 will be described with reference to FIG. 17 and FIG. 18. The water treatment apparatus of Embodiment 5 is characterized by measuring the spectral light intensity in at least three locations (entrance and exit of the ozone treatment tank 2, and one or more locations there between), and controlling the ozone injection rate using the UV 254 residual rate even if the ozone injection rate is an ozone injection rate at which the residual ozone is detected at a predetermined water temperature or less.

Step S102 in FIG. 17 according to Embodiment 5 is the same as the above mentioned step S102 in FIG. 2 according to Embodiment 1. Step S203 in FIG. 17 according to Embodiment 5 is the same as the above mentioned step S203 in FIG. 8 according to Embodiment 2. Further, steps S403 to S406, S410 and S411 in FIG. 17 according to Embodiment 5 are the same as the above mentioned steps S403 to S406, S410 and S411 in FIG. 14 according to Embodiment 4. Therefore the steps added in Embodiment 5 will be primarily described below.

In step S501 of the flow chart in FIG. 17, it is assumed that the untreated water 3 is contained in the ozone treatment tank 2, and the water treatment method of Embodiment 5 is started in a state where ozone treatment is performed for the untreated water 3.

Therefore the following description concerns the state after the dissolved ozone concentration constant control method has just switched to the water treatment method of Embodiment 5. Here it is assumed that the water treatment method of Embodiment 5 is started in a state where dissolved ozone is detected in the ozone treated water.

In step S502, the control unit 10 starts the water treatment method of Embodiment 5 when the water temperature is less than a predetermined temperature. In the case of a low water temperature period, such as winter time, self-decomposition of ozone is suppressed, hence dissolved ozone may be detected at a low ozone injection rate, and the ozone required for decomposing organic substances may not be sufficiently injected into the untreated water. In the following description, it is assumed that the predetermined temperature is a 10° C. water temperature. A case of measuring the absorbance at a 254 nm wavelength (UV 254) using the ultraviolet absorbance measuring instrument 45 will be described as an example.

A series of processing operations in steps S102 and S403 to S406 in the flow chart according to Embodiment 5 in FIG. 17 are the same as the above mentioned flow chart according to Embodiment 4 in FIG. 14. Then in step S406, the control unit 10 determines the ozone injection rate Xc and processing then advances to step S410.

Then if the ozone injection rate Oc satisfies the above Expression (7) in step S410, processing returns to step S502, and the control unit 10 repeatedly executes the ozone injection rate control according to Embodiment 5. If Expression (7) is not satisfied, on the other hand, processing advances to step S411, and the control unit 10 increases the ozone injection rate until the above Expression (7) is satisfied.

Then in step S503, the control unit 10 determines whether the predetermined concentration or less of the dissolved ozone is detected in the measurement location C. If the dissolved ozone concentration is the predetermined concentration or less, processing returns to step S502, and the control unit 10 repeatedly executes the ozone injection rate control according to Embodiment 5.

If the dissolved ozone concentration is not the predetermined concentration or less, processing advances to step S504, and the control unit 10 decreases the ozone injection rate until the dissolved ozone becomes the predetermined concentration or less. Here the predetermined concentration of the dissolved ozone detected in the measurement location C is in a 0.1 mg/L to 2.0 mg L range, for example. It is preferable that the control unit 10 controls the dissolved ozone concentration to 0.5 mg/L or less.

As depicted in FIG. 18, in a low water temperature period, such as winter time, an inflection point at which slope of the UV 254 residual rate with respect to the ozone injection rate lessens, as depicted in FIG. 3, does not exist in the range of the ozone injection rate at which dissolved ozone is detected. This is because in such a low water temperature period as winter time, the self-decomposition speed of ozone is slow, hence dissolved ozone is detected at a low ozone injection rate.

In the measurement location A, which is at the entrance of the reaction tank, the ozone injection rate is 0 mg/L and the UV 254 residual rate is 100%. Therefore the control unit 10 generates the above Expression (5) using the UV 254 residual rates in the measurement locations A and B, where the UV 254 residual rate decreases with respect to the ozone injection rate. Here if the UV%c in the measurement location C is substituted for Y of the above Expression (5) and the ozone injection rate Xc is determined, the relationship of the above Expression (7) is not established.

Hence, the control unit 10 increases the ozone injection rate in the measurement location C until the relationship of the above Expression (7) is established, and the ozone injection rate is set to Xuv at which the relationship of the above Expression (7) is established. If the dissolved ozone exceeding the predetermined concentration is detected in the measurement location C at this time, the control unit 10 decreases the ozone injection rate until the dissolved ozone concentration becomes the predetermined concentration or less, and sets the highest ozone injection rate Xuv, at which the relationship of the above Expression (7) is established, and the dissolved ozone becomes the predetermined concentration or less.

By using the dissolved ozone concentration as the upper limit of the ozone injection rate like this, the generation amount of the bromate does not increase very much, even if the ozone injection rate is an ozone injection rate at which dissolved ozone is detected, and both the decomposition of the organic substances and the suppression of the generation of bromate can be implemented.

In Embodiment 5, the UV 254 residual rate is measured at an ozone injection rate at which dissolved ozone is detected. Therefore UV 254 is measured after aerating the sampled untreated water 3, eliminating the dissolved ozone. As a result, the change in UV 254 can be accurately measured.

In the case of the dissolved ozone concentration constant control method, it is unknown whether the amount of ozone required for decomposing the organic substances in the untreated water has been injected. In the case of Embodiment 5, on the other hand, the ozone injection rate is controlled using the UV 254 residual rate, which is correlated with the organic substances, as an index, hence the amount of ozone required for decomposing organic substances can be injected into the untreated water, regardless whether dissolved ozone is detected.

In the description of the water treatment according to Embodiment 5, the ultraviolet absorbance measuring instrument 45 is used for the spectral light intensity measuring unit 42 as an example, but the fluorescence intensity measuring instrument may be used for the spectral light intensity measuring unit. In the case of using the fluorescence intensity measuring instrument, fluorescence at any wavelength in a 400 nm to 460 nm range is measured by exciting the untreated water with light at any wavelength in a 200 nm to 370 nm range, which has high correlation with the humic substances in the untreated water.

Preferably the fluorescence at a 450 nm wavelength is measured by exciting the untreated water using the light at a 260 nm wavelength. It is known that the fluorescence intensity is quenched by dissolved oxygen, temperature, concentration and coexisting substances. Therefore when the water treatment according to Embodiment 5 is performed using fluorescence intensity, a predetermined concentration of a fluorescent substance is added to the measurement sample, and the measured value is evaluated as a relative value with respect to the fluorescence intensity of the added fluorescent substance.

The fluorescent substance is added to the treated water, after the treated water is aerated and dissolved ozone is eliminated. The fluorescence intensity measurement, which is highly correlated to humic substances, is not affected by dissolved ozone. However, if dissolve ozone remains in the treated water, the fluorescent substance added to the ozone treated water may be decomposed by ozone.

Therefore the fluorescent substance is added to the ozone treated water after dissolved ozone is eliminated from the ozone treated water by aeration. Thereby decomposition of the fluorescent substance by ozone can be prevented. Further, the accuracy of the relative evaluation of the fluorescence intensity in each measurement location can be increased if suspended substances are eliminated before measuring the fluorescence intensity.

The water treatment apparatus according to Embodiment 5 measures the fluorescence intensity in each measurement location A to C, calculates the relative fluorescence intensity in each measurement location, then estimates the ozone injection rate at which the slope of the residual rate of the relative fluorescence intensity with respect to the ozone injection rate lessens, using the same method as the case of using UV 254. Then the control unit 10 controls the ozone injection rate targeting this estimated ozone injection rate.

As described above, the water treatment method according to Embodiment 5 uses a configuration to measure the ultraviolet absorbance or the fluorescence intensity at a wavelength correlated with the organic substance concentration in a plurality of locations in the ozone treatment tank 2. Therefore the ozone injection rate can be controlled in accordance with the water quality of the untreated water.

Further, in the case when the water temperature is low and the dissolved ozone is detected at a low ozone injection rate, the ozone injection rate required for decomposing organic substances in the untreated water can be maintained, even in a range of ozone injection rate at which dissolved ozone is detected.

Moreover, the ozone injection rate can be controlled in accordance with the change in water quality and the change in water quantity, by switching the dissolved ozone concentration constant control method and the ozone injection rate control method according to Embodiment 5, depending on whether the water temperature of the untreated water is less than a predetermined temperature.

1-15. (canceled)

16: A water treatment apparatus, comprising:
an ozone injection facility configured to inject ozone gas into a treatment tank into which untreated water is introduced to be stored therein;
a measuring unit configured to measure a spectral light intensity of the untreated water in a plurality of locations by using at least a first wavelength; and
a controller configured to estimate, for treated water, which has been treated with ozone in the treatment tank or for both the treated water and the untreated water, a residual rate of the spectral light intensity at the first wavelength, based on measurement results in the plurality of locations, measured by the measuring unit, and control an ozone injection rate of the ozone injection facility by using the estimated residual rate.

17: The water treatment apparatus of claim 16, wherein
the untreated water contains a humic substance and an organic substance correlated with ultraviolet absorbance at a first wavelength,
the measuring unit includes:
a first measuring instrument configured to measure ultraviolet absorbance at two or more types of wavelengths including the first wavelength and a second wavelength for the untreated water to be introduced into the treatment tank; and
a third measuring instrument configured to measure ultraviolet absorbance at a first wavelength for the treated water which has been treated with ozone in the treatment tank,
a third measuring instrument configured to measure ultraviolet absorbance at a first wavelength for the treated water which has been treated with ozone in the treatment tank,
the first wavelength is 240 nm or more and 270 nm or less, and the second wavelength is 200 nm or more and 230 nm or less, and
when the ozone injection rate is controlled based on the estimated residual rate, the controller
calculates a residual rate estimated value of the ultraviolet absorbance at the first wavelength of the treated water from the measured value at the second wavelength by the first measuring instrument, and sets the calculated value as a target value,
calculates the residual rate measured value of the ultraviolet absorbance at the first wavelength of the treated water by dividing the measured value at the first wavelength of the third measuring instrument by the measured value at the first wavelength of the first measuring instrument, and
controls the ozone injection rate so as to minimize a difference between the residual rate estimated value of the ultraviolet absorbance at the first wavelength, which has been set as the target value, and the residual rate measured value of the ultraviolet absorbance at the first wavelength of the treated water.

18: The water treatment apparatus of claim 16, wherein
the untreated water contains a humic substance and an organic substance correlated with ultraviolet absorbance at a first wavelength,
when the plurality of locations are three locations constituted by a first measurement location that is set at an entrance of the treatment tank, a second measurement location that is set in the treatment tank, and a third measurement location that is set at an exit of the treatment tank,
the measuring unit includes:
a first measuring instrument configured to measure the ultraviolet absorbance at the first wavelength for the untreated water in the first measurement location;
a second measuring instrument configured to measure the ultraviolet absorbance at the first wavelength for the untreated water in the second measurement location; and
a third measuring instrument configured to measure the ultraviolet absorbance at the first wavelength for the treated water in the third measurement location,
the first wavelength is 240 nm or more and 270 nm or less, and
the controller
calculates, as a first residual rate, the residual rate of the ultraviolet absorbance at the first wavelength of the untreated water in the first measurement location, based on the measured value by the first measuring instrument,
calculates, as a second residual rate, the residual rate of the ultraviolet absorbance at the first wavelength of the untreated water in the second measurement location, based on the measured value by the second measuring instrument,
calculates, as a third residual rate, the residual rate of the ultraviolet absorbance at the first wavelength of the treated water in the third measurement location based on the measured value by the third measuring instrument,
generates a linear function derived from the first residual rate and the second residual rate, and
calculates an independent variable in the linear function where the third residual rate is a dependent variable, and controls the ozone injection rate based on the calculated independent variable.

19: The water treatment apparatus according to claim 16, wherein
the untreated water contains an organic substance correlated with ultraviolet absorbance at a first wavelength,
when the plurality of locations are three locations constituted by a first measurement location that is set at an entrance of the treatment tank, a second measurement location that is set in the treatment tank, and a third measurement location that is set at an exit of the treatment tank,
exciting light at the first wavelength has a 200 nm wavelength or more and a 370 nm wavelength or less and fluorescence at the first wavelength has is a 400 nm wavelength or more and a 460 nm wavelength or less,
the measuring unit includes:
a first measuring instrument configured to measure the fluorescence intensity at the first wavelength for the untreated water in the first measurement location; a second measuring instrument configured to measure the fluorescence intensity at the first wavelength for the untreated water in the second measurement location; and a third measuring instrument configured to measure the fluorescence intensity at the first wavelength for the treated water in the third measurement location, and
the controller
calculates, as a first residual rate, the residual rate of the fluorescence intensity at the first wavelength of the untreated water in the first measurement location, based on the measured value by the first measuring instrument,
calculates, as a second residual rate, the residual rate of the fluorescence intensity at the first wavelength of the untreated water in the second measurement location, based on the measured value by the second measuring instrument,
calculates, as a third residual rate, the residual rate of the fluorescence intensity at the first wavelength of the treated water in the third measurement location, based on the measured value by the third measuring instrument,
generates a linear function derived from the first residual rate and the second residual rate, and
calculates an independent variable in the linear function where the third residual rate is a dependent variable, and controls the ozone injection rate based on the calculated independent variable.

20: The water repellent apparatus of claim 17, further comprising a water thermometer configured to measure a water temperature of the untreated water, wherein
the controller
controls the ozone injection rate based on a dissolved ozone concentration of the untreated water when the water temperature of the untreated water is in a first temperature range,
controls the ozone injection rate so that the dissolved ozone concentration becomes a detection lower limit value or less, when the water temperature of the untreated water is in a second temperature range, where the temperature is higher than the first temperature range, and
controls the ozone injection rate based on the measured value of spectral light intensity when the water temperature of the untreated water is in a third temperature range, where the temperature is lower than the first temperature range.

21: The water treatment apparatus of claim 20, wherein when the water temperature measured by the water thermometer is in a temperature range of 0° C. or more and less than 50° C., the controller determines that
the first temperature range is 10° C. or more and less than 25° C.,
the second temperature range is 25° C. or more and less than 50° C., and
the third temperature range is 0° C. or more and less than 10° C.

22: The water treatment apparatus of claim 17, further comprising a suspended substance eliminator for eliminating a suspended substance, disposed in both a preceding stage of the first measuring instrument and a preceding stage of the third measuring instrument.

23: The water treatment apparatus of claim 17, further comprising a pH adjuster for adjusting a pH value to a desired value, disposed in both the preceding stage of the first measuring instrument and the preceding stage of the third measuring instrument.

24: The water treatment apparatus of claim 23, wherein
the pH adjustor adjusts pH values of the untreated water and the treated water to desired values, which are in a 7.4 to 7.8 range.

25: The water treatment apparatus of claim 17, further comprising an aerator for aerating the treated water, the aerator being disposed in the preceding stage of the third measuring instrument.

26: The water treatment apparatus of claim 17, further comprising a cleaning mechanism configured to clean the first measuring instrument and the third measuring instrument by using water containing ozone.

27: A water treatment apparatus, comprising:
an ozone injection facility configured to inject ozone gas into a treatment tank into which untreated water is introduced to be stored therein;
a first measuring instrument configured to measure ultraviolet absorbance at two or more types of wavelengths, including a first wavelength and a second wavelength, for the untreated water introduced into the processing tank;
a third measuring instrument configured to measure ultraviolet absorbance at the first wavelength for the treated water which has been treated with ozone in the treatment tank;
a controller configured to control an ozone injection rate of the ozone injection facility, based on measurement results by the first measuring instrument and the third measurement instrument; and
a compact water treatment apparatus configured to introduce the untreated water, perform ozone treatment thereon, and calculate a target value of the ozone injection rate in real-time, based on a result of the ozone treatment, wherein
the controller
calculates the residual rate measured value of the ultraviolet absorbance at the first wavelength of the treated water by dividing the measured value at the first wavelength of the third measuring instrument by the measured value at the first wavelength of the first measuring instrument, and
controls the ozone injection rate so as to minimize a difference between a target value of the ozone injection rate calculated by the compact water treatment apparatus and the residual rate measured value of the ultraviolet absorbance at the first wavelength of the treated water.

28: A water treatment method, comprising:
an ozone injection step of injecting ozone gas into a treatment tank into which untreated water is introduced to be stored therein;
a measurement step of measuring a spectral light intensity of the untreated water in a plurality of locations by using at least a first wavelength;
a step of estimating a residual rate of the spectral light intensity at the first wavelength, for treated water, which has been treated with ozone in the treatment tank or for both the treated water and the untreated water, based on measurement results in the plurality of locations, measured in the measurement step; and
a control step of controlling an ozone injection rate in the ozone injection step using the estimated residual rate.
